(19) United States
(12) Patent Application Publication
(10) Pub. No.: US 2025/0159643 A1
(43) Pub. Date: May 15, 2025

(54) AREA INFORMATION FOR POSITIONING

(71) Applicant: QUALCOMM Incorporated, San Diego, CA (US)

(72) Inventors: Mohammed Ali Mohammed HIRZALLAH, San Marcos, CA (US); Taesang YOO, San Diego, CA (US); Rajat PRAKASH, San Diego, CA (US)

(21) Appl. No.: 18/505,371

(22) Filed: Nov. 9, 2023

(51) Int. Cl. H04W 64/00; H04L 5/00

(52) U.S. Cl. CPC H04W 64/00; H04L 5/0048

(57) ABSTRACT

Disclosed are techniques for communication. In an aspect, a user equipment may receive area information for one or more areas, the area information including area identifiers (IDs) of the one or more areas, an area description of the one or more areas, or both. The user equipment may transmit an indication of support for area-specific positioning in at least a first area of the one or more areas.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication at a user equipment (UE) comprises receiving area information for one or more areas. The area information can include area identifiers (IDs) of the one or more areas, an area description of the one or more areas, or both. The method further comprises transmitting an indication of support for area-specific positioning in at least a first area of the one or more areas.

In an aspect, a method of wireless communication at a user equipment comprises transmitting a message identifying one or more UE-initiated areas, the message including an area ID, area description, or both for the one or more UE-initiated areas.

In an aspect, a method of communication at a network entity comprises transmitting area information for one or more areas to a user equipment. The area information can include area identifiers of the one or more areas, an area description of the one or more areas, or both; and receiving an indication of support for area-specific positioning in at least a first area of the one or more areas.

In an aspect, a method of communication at a network entity comprises receiving, from a user equipment, a message identifying one or more UE-initiated areas. The message can include an area ID, area description, or both for the one or more UE-initiated areas.

In an aspect, a user equipment includes one or more memories; one or more transceivers; and one or more processors communicatively coupled to the one or more memories and the one or more transceivers, the one or more processors, either alone or in combination, configured to: receive, via the one or more transceivers, area information for one or more areas. The area information can include area identifiers of the one or more areas, an area description of the one or more areas, or both. The UE is further configured to transmit, via the one or more transceivers, an indication of support for area-specific positioning in at least a first area of the one or more areas.

In an aspect, a user equipment includes one or more memories; one or more transceivers; and one or more processors communicatively coupled to the one or more memories and the one or more transceivers, the one or more processors, either alone or in combination, configured to: transmit, via the one or more transceivers, a message identifying one or more UE-initiated areas. The message can include an area ID, area description, or both for the one or more UE-initiated areas.

In an aspect, a network entity includes one or more memories; one or more transceivers; and one or more processors communicatively coupled to the one or more memories and the one or more transceivers, the one or more processors, either alone or in combination, configured to: transmit, via the one or more transceivers, area information for one or more areas to a user equipment. The area information can include area identifiers of the one or more areas, an area description of the one or more areas, or both; and receive, via the one or more transceivers, an indication of support for area-specific positioning in at least a first area of the one or more areas.

In an aspect, a network entity includes one or more memories; one or more transceivers; and one or more processors communicatively coupled to the one or more memories and the one or more transceivers, the one or more processors, either alone or in combination, configured to: receive, via the one or more transceivers, from a user equipment, a message identifying one or more UE-initiated areas. The message can include an area ID, area description, or both for the one or more UE-initiated areas.

In an aspect, a user equipment (UE) includes means for receiving area information for one or more areas, the area information including area identifiers (IDs) of the one or more areas, an area description of the one or more areas, or both; and means for transmitting an indication of support for area-specific positioning in at least a first area of the one or more areas.

In an aspect, a user equipment (UE) includes means for transmitting a message identifying one or more UE-initiated areas, the message including an area identifier (ID), area description, or both for the one or more UE-initiated areas.

In an aspect, a network entity includes means for transmitting area information for one or more areas to a user equipment (UE), the area information including area identifiers (IDs) of the one or more areas, an area description of the one or more areas, or both; and means for receiving an indication of support for area-specific positioning in at least a first area of the one or more areas.

In an aspect, a network entity includes means for receiving, from a user equipment (UE), a message identifying one or more UE-initiated areas, the message including an area identifier (ID), area description, or both for the one or more UE-initiated areas.

In an aspect, a non-transitory computer-readable medium stores computer-executable instructions that, when executed by a user equipment (UE), cause the user equipment to: receive area information for one or more areas, the area information including area identifiers (IDs) of the one or more areas, an area description of the one or more areas, or both; and transmit an indication of support for area-specific positioning in at least a first area of the one or more areas.

In an aspect, a non-transitory computer-readable medium stores computer-executable instructions that, when executed by a user equipment (UE), cause the user equipment to: transmit a message identifying one or more UE-initiated areas, the message including an area identifier (ID), area description, or both for the one or more UE-initiated areas.

In an aspect, a non-transitory computer-readable medium stores computer-executable instructions that, when executed by a network entity, cause the network entity to: transmit area information for one or more areas to a user equipment (UE), the area information including area identifiers (IDs) of the one or more areas, an area description of the one or more areas, or both; and receive an indication of support for area-specific positioning in at least a first area of the one or more areas.

In an aspect, a non-transitory computer-readable medium stores computer-executable instructions that, when executed by a network entity, cause the network entity to: receive, from a user equipment (UE), a message identifying one or more UE-initiated areas, the message including an area identifier (ID), area description, or both for the one or more UE-initiated areas.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 is a graph representing a radio frequency (RF) channel impulse response over time, according to aspects of the disclosure.

FIG. 6 illustrates an example neural network, according to aspects of the disclosure.

FIG. 7A is a diagram illustrating an example of direct artificial intelligence/machine learning (AI/ML) positioning, according to aspects of the disclosure.

FIG. 7B is a diagram illustrating an example of AI/ML assisted positioning, according to aspects of the disclosure.

FIG. 8 illustrates various AI/ML positioning scenarios, according to aspects of the disclosure.

FIG. 9 shows an illustration of an example network region according to some currently described positioning techniques.

FIG. 10 shows an illustration of an example network region, according to aspects of the disclosure.

FIG. 11 shows an example network region with hierarchically organized areas, according to aspects of the disclosure.

FIGS. 12 to 19 illustrate example methods of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to positioning. Some aspects more specifically relate to area-specific positioning techniques, such as Artificial Intelligence/Machine Learning (AI/ML) positioning. In some examples, a network entity and/or user equipment (UE) can communicate area information and/or support for area-specific positioning such as AI/ML positioning. Area-specific positioning can be particularly important in environments that are challenging for some existing positioning techniques. Some of the enhancements described herein include UE-initiated areas. For the example of AI/ML positioning, this allows the UE to register AI/ML positioning capability on a per-area level. Additionally, geospatial indications and timing indications for UE-initiated and/or network-initiated areas can be used, rather than identification of areas based on TRP identifier. Further, areas may be associated with identifiers at different hierarchy levels in addition to an area identifier (area ID). For example, an area listing can embrace one or more areas with some commonality, and the area listings can have associated area listing identifiers (area listing IDs). In a hierarchical organization, a particular area can be associated with both an area ID and an area listing ID. Areas from different area listings can be considered, and can overlap and contain multiple non-contiguous segments (as described in more detail below). The different area listings can enable indication of different positioning capabilities, including generalization, performance, complexity, reporting, etc.

Particular aspects of the subject matter described in this disclosure can be implemented to realize one or more of the following potential advantages. Enabling the UE to indicate support for area-specific (e.g., AI/ML) positioning in specific sites/areas can enhance positioning accuracy efficiently. UE area identification/definition can provide smart granularity for area-specific positioning, as well as the ability to adapt to changes in UE AI/ML capability. Bi-directional communication allows the network and UE to coordinate to meet positioning goals for different environments. For example, the network and/or UE can activate or deactivate the area-specific positioning based on UE location (and current time if the area-specific positioning is associated with timing parameters), or switch to a different or fallback positioning technique if appropriate.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

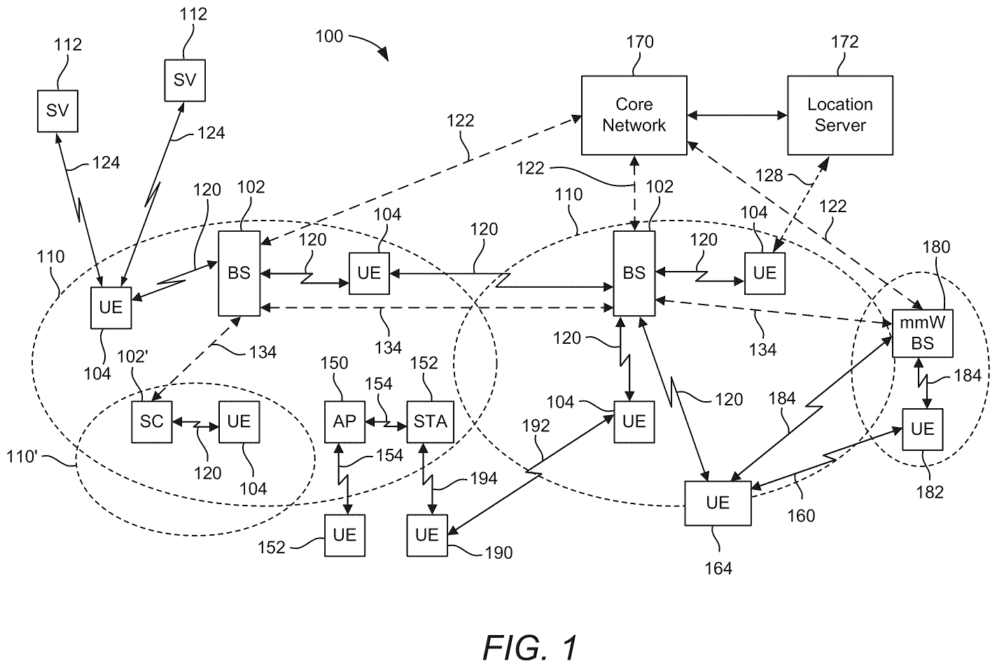

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1: M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

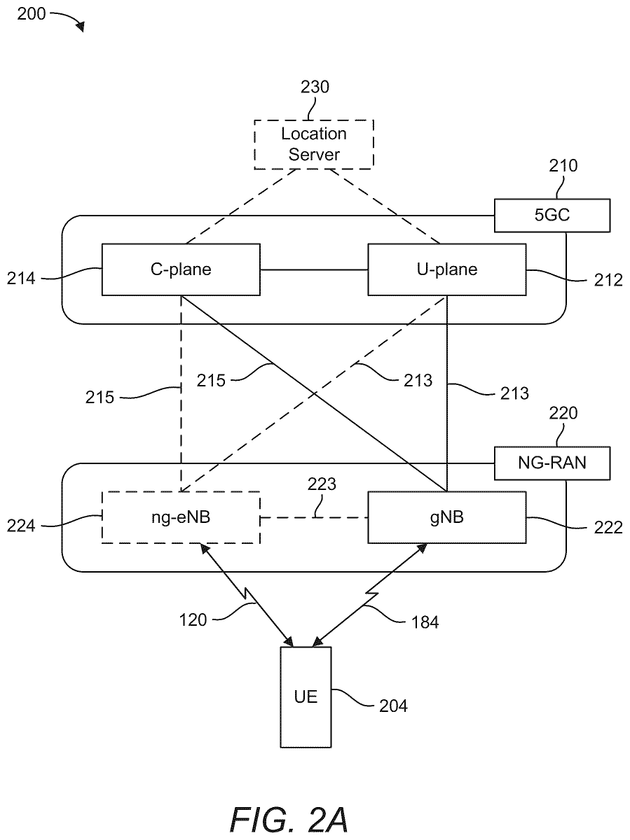

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

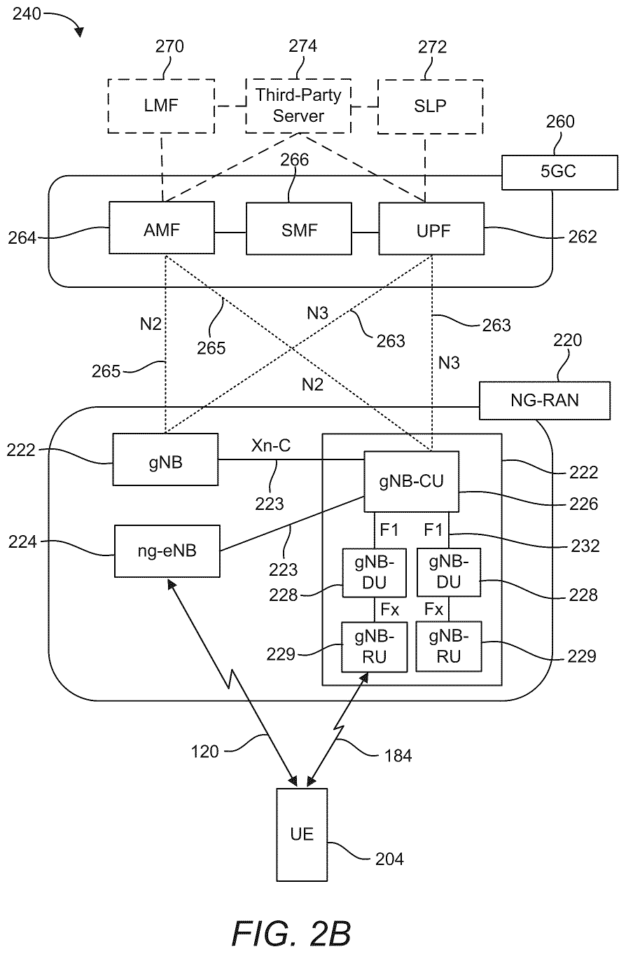

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS®) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more

WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

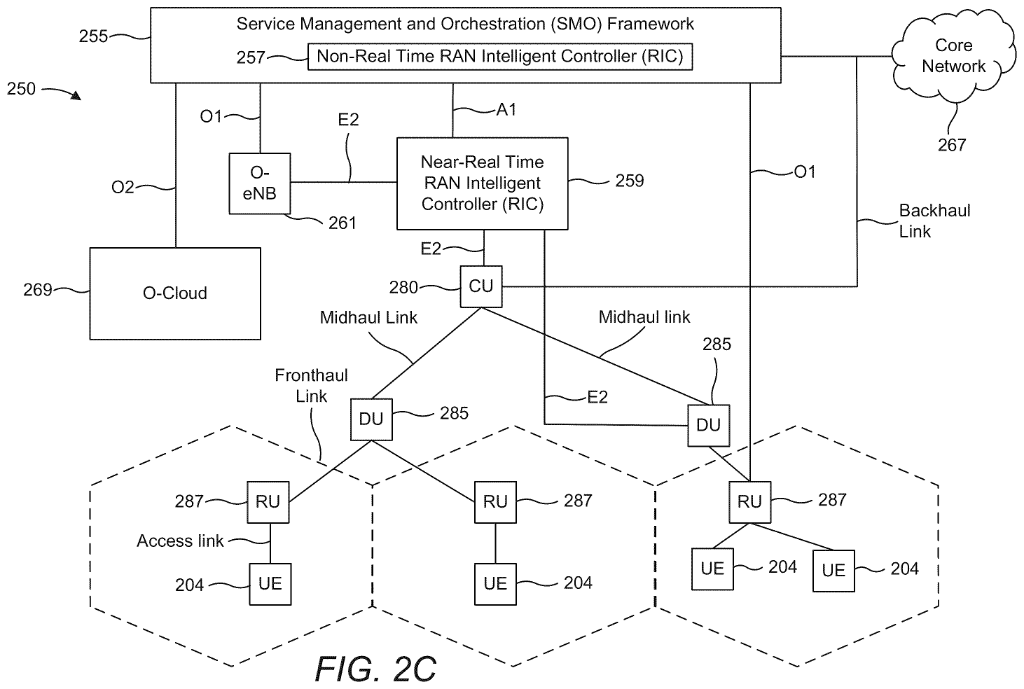

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

As noted above, a UE may measure PRS transmitted by one or more TRPs. A “PRS resource” is a collection of resource elements (REs) that are used for transmission of PRS. The collection of resource elements can span multiple physical resource blocks (PRBs) in the frequency domain and ‘N’ (such as 1 or more) consecutive symbol(s) within a slot in the time domain. In a given orthogonal frequency division multiplexing (OFDM) symbol in the time domain, a PRS resource occupies consecutive PRBs in the frequency domain.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with u=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), SSBs, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

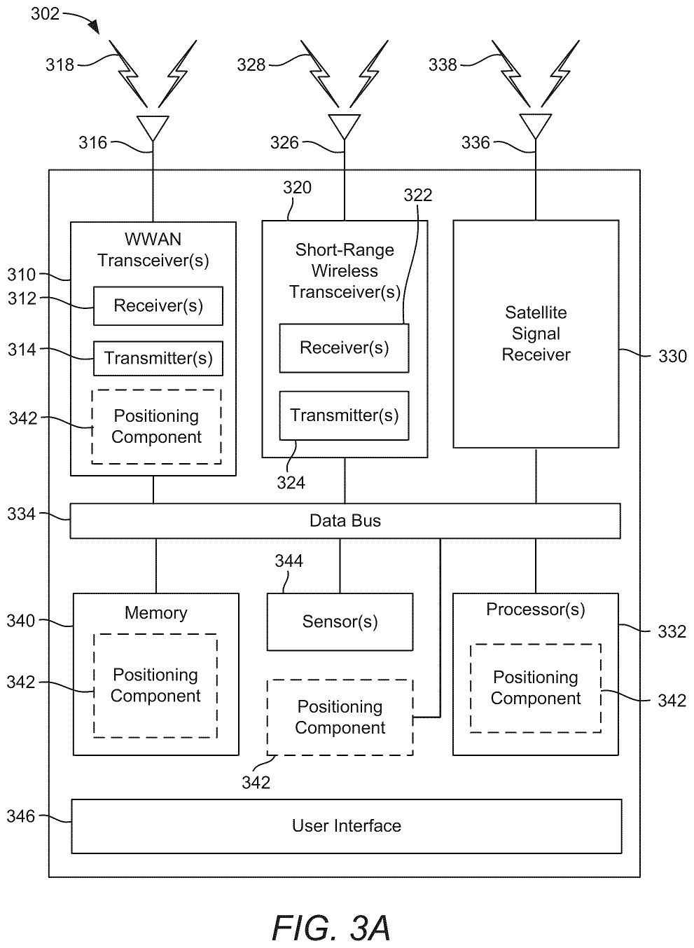

FIG. 5 is a graph 500 representing an example channel estimate of a multipath channel between a receiver device (e.g., any of the UEs or base stations described herein) and a transmitter device (e.g., any other of the UEs or base stations described herein), according to aspects of the disclosure. The channel estimate represents the intensity of a radio frequency (RF) signal (e.g., a positioning reference signal (PRS)) received through a multipath channel as a function of time delay, and may be referred to as the channel energy response (CER), channel impulse response (CIR), or power delay profile (PDP) of the channel. Thus, the horizontal axis represents time (e.g., milliseconds) and the vertical axis represents signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 5, the receiver detects/measures multiple (four) channel taps of the RF signal. Each channel tap is a cluster of one or more rays and corresponds to a multipath that the RF signal followed between the transmitter and the receiver. Thus, a channel tap represents the time of arrival and signal strength of an RF signal over a multipath. There may be multiple channel taps due to the RF signal being transmitted on different transmit beams (and therefore at different angles), or because of the propagation characteristics of RF signals (e.g., potentially following different paths due to reflections), or both. Note that although FIG. 5 illustrates channel taps of two to five rays, as will be appreciated, the channel taps may have more or fewer than the illustrated number of rays.

In the example of FIG. 5, the channel tap detected at time T3 is composed of stronger rays than the channel tap detected at time T1. This may be due to an obstruction on the line-of-sight (LOS) path between the transmitter and the receiver. Alternatively or additionally, there may be a strong reflector along the non-line-of-sight (NLOS) path corresponding to the channel tap detected at time T3.

Machine learning (also referred to as “artificial intelligence/machine learning,” “AI/ML,” or “AIML”) may be used to generate models that may be used to facilitate various aspects associated with processing of data. One specific application of machine learning relates to generation of measurement models for the processing of reference signals (e.g., PRS) for positioning purposes, such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

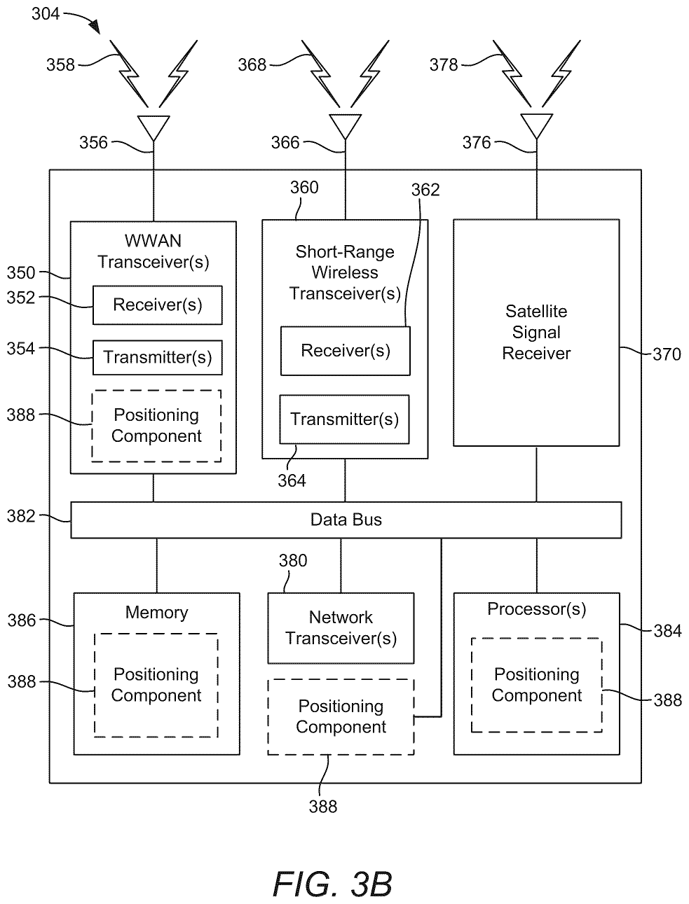

FIG. 6 illustrates an example neural network 600, according to aspects of the disclosure. The neural network 600 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system, such as processors 332, 384, or 394) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

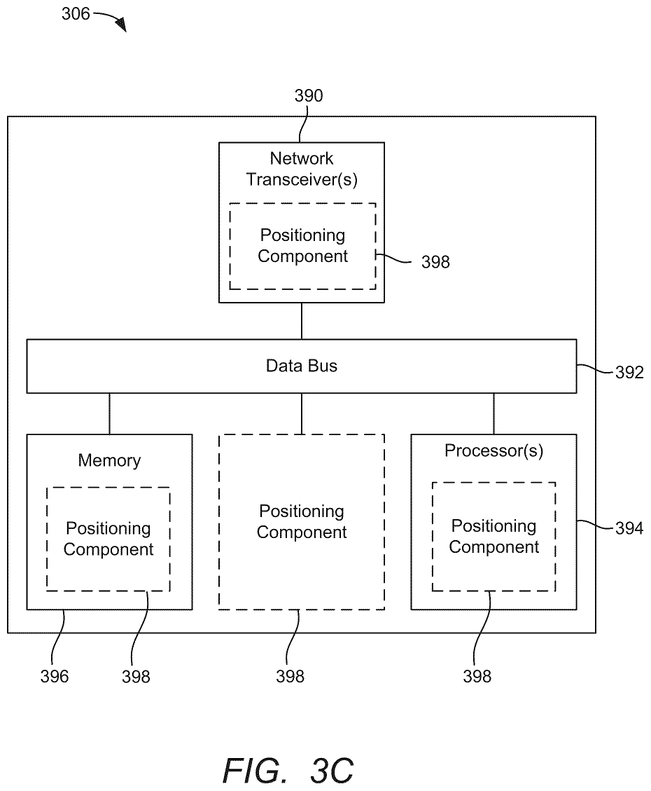

The artificial intelligence/machine learning (AI/ML) positioning provided by an AI/ML positioning model may be direct AI/ML positioning or AI/ML assisted positioning. FIG. 7A is a diagram 700 illustrating an example of direct AI/ML positioning, according to aspects of the disclosure. As shown in FIG. 7A, direct AI/ML positioning is where the input features (or simply “inputs” or “features”) to the AI/ML positioning model are measurements of one or more reference signals (e.g., DL-PRS or SRS) and the output label (or simply “output” or “label”) of the AI/ML positioning model is the target (estimated) location of the UE. The measurements of the reference signal(s) may include the channel energy response (CER), channel impulse response (CIR), channel frequency response (CFR), received signal strength indicator (RSSI), reference signal received power (RSRP), path RSRP (RSRPP), reference signal received quality (RSRQ), time of arrival (ToA), relative ToA (RTOA), reference signal time difference (RSTD), angle of departure (AoD), angle of arrival (AoA), and/or the like of the reference signal(s).

FIG. 7B is a diagram 750 illustrating an example of AI/ML assisted positioning, according to aspects of the disclosure. As shown in FIG. 7B, AI/ML assisted positioning is where the input features to the AI/ML positioning model are measurements of one or more reference signals (e.g., DL-PRS, SRS) and the output labels of the AI/ML positioning model are intermediate measurements (or quantities) of the reference signal(s). The target location of the UE is then determined using non-artificial intelligence techniques (e.g., Chan's algorithm, Kalman filtering, etc.) or a different machine learning model. In this case, the measurements of the reference signal(s) may include the CER, CIR, CFR, RSSI, RSRP, RSRPP, RSRQ, and/or the like of the reference signal(s). The intermediate measurements of the reference signal(s) may include the ToA, RTOA, RSTD, AoD, AoA, line-of-sight (LOS) indication, and/or the like of the reference signal(s).

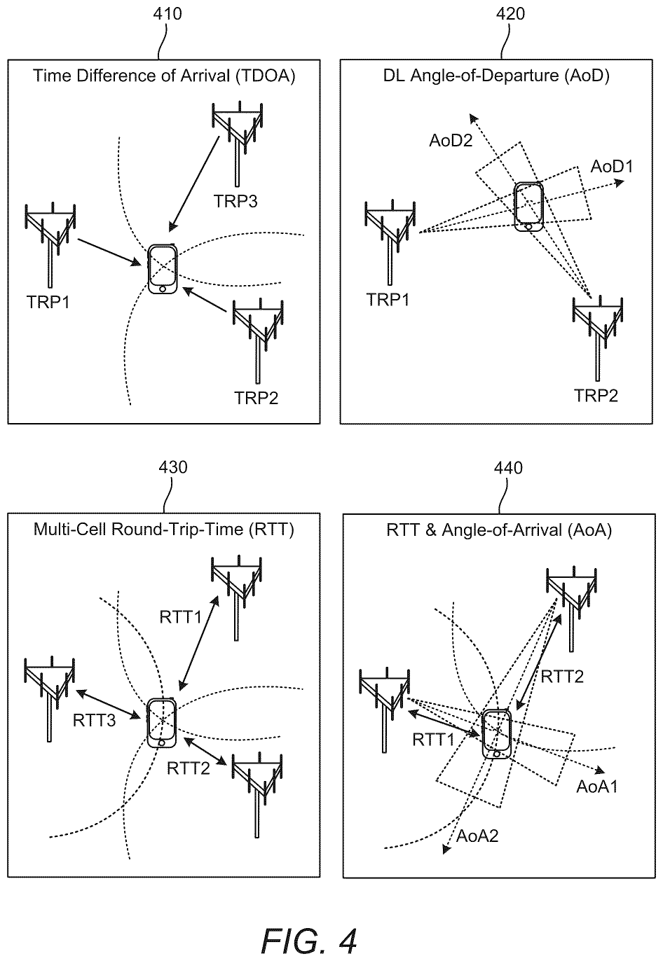

FIG. 8 illustrates various artificial intelligence/machine learning (AI/ML) positioning scenarios, according to aspects of the disclosure. As shown in diagram 800, there are three AI/ML positioning deployment scenarios based on downlink reference signals (e.g., DL-PRS). The first deployment scenario (labeled “Case 1”) is a UE-based positioning case with a UE-side AI/ML positioning model (labeled “AI/ML”). In this case, the UE applies the AI/ML positioning model (or simply “AI/ML model”) to determine a target location of the UE and reports the target location to the LMF (e.g., LMF 270). The AI/ML positioning provided by the AI/ML positioning model may be direct AI/ML (D-AI/ML) positioning or AI/ML assisted (A-AI/ML) positioning.

The second deployment scenario (labeled “Case 2a”) is UE-assisted/LMF-based positioning with a UE-side AI/ML positioning model that provides AI/ML assisted positioning. That is, the UE inputs measurements of downlink reference signals (e.g., DL-PRS) received from one or more TRPs into the AI/ML positioning model to obtain intermediate measurements (or quantities) of the downlink reference signals. The UE then reports the intermediate measurements to the LMF (e.g., LMF 270). As noted above, for AI/ML assisted positioning, the measurements of the downlink reference signals may include the CER, CIR, CFR, RSSI, RSRP, RSRPP, RSRQ, and/or the like of the downlink reference signals. The intermediate measurements of the downlink reference signals may include the ToA, RSTD, AoD, AoA, line-of-sight (LOS) indication, and/or the like of the downlink reference signals.

The third deployment scenario (labeled “Case 2b”) is UE-assisted/LMF-based positioning with an LMF-side model that provides direct AI/ML positioning. That is, the UE reports the measurements of the downlink reference signals received from one or more TRPs to the LMF (e.g., LMF 270). The LMF then applies the AI/ML positioning model to the measurements to determine the target location of the UE. In this case, the measurements of the downlink reference signals reported to the LMF may include the CER, CIR, CFR, RSSI, RSRP, RSRPP, RSRQ, ToA, RSTD, AoD, AoA, LOS indication, and/or the like of the downlink reference signals.

As shown in diagram 850, there are two AI/ML positioning deployment scenarios based on uplink reference signals (e.g., SRS). The first deployment scenario (labeled “Case 3a”) is NG-RAN node-assisted positioning with an NG RAN-side model that provides AI/ML assisted positioning. In this case, the NG-RAN applies an AI/ML positioning model to TRP measurements of one or more uplink reference signals (e.g., SRS) transmitted by a UE to obtain intermediate measurements of the received uplink reference signal(s). The NG-RAN then reports the intermediate measurements to the LMF (e.g., LMF 270). As noted above, for AI/ML assisted positioning, the measurements of the uplink reference signal(s) may include the CER, CIR, CFR, RSSI, RSRP, RSRPP, RSRQ, and/or the like of the uplink reference signal(s). The intermediate measurements of the uplink reference signal(s) may include the RTOA, RSTD, AoD, AoA, LOS indication, and/or the like of the uplink reference signal(s).

The second deployment scenario (labeled “Case 3b”) is NG-RAN node-assisted positioning with an LMF-side AI/ML positioning model that provides direct AI/ML positioning. In this case, the NG-RAN reports measurements of one or more uplink reference signals received from a UE to the LMF (e.g., LMF 270). The LMF then applies an AI/ML positioning model to the measurements of the uplink reference signal(s) to obtain a target location of the UE. The measurements of the uplink reference signal(s) may include the CER, CIR, CFR, RSSI, RSRP, RSRPP, RSRQ, RTOA, RSTD, AOD, AoA, LOS indication, and/or the like of the uplink reference signal(s).

Note that there may be other deployment scenarios in which the UE, NG-RAN, or LMF use an AI/ML positioning model to compute or report a positioning estimate (target location), but these cases are implementation-specific and do not necessarily involve signaling between the UE, NG-RAN, and/or LMF.

As outlined in the examples above, a target device such as a UE may be able to implement a number of positioning techniques, depending on its capabilities and positioning environment. Some positioning techniques may be performed at the UE without network participation, while many techniques involve both the UE and one or more network devices such as a eNodeB, gNodeB, location server, etc. At different times, a UE may be located in different environments with different positioning challenges.

For a UE in an outdoor environment with good reception of terrestrial and non-terrestrial signals, existing satellite and cellular network positioning techniques may enable efficient and accurate positioning. In other environments, it may be more difficult to obtain an accurate position with these methods. For example, a UE in an environment with a higher density of reflecting and absorbing objects (such as an “urban canyon” environment) can be more susceptible to multipath and may have less access to line of site (LOS) positioning signals. In another example, a UE may be in an indoor environment where some positioning signals may be difficult (or impossible) to detect. The current disclosure provides techniques for area-specific positioning types that can improve positioning, particularly in areas that may be challenging for traditional positioning types.

Within types of positioning environments, there can be additional differences. For example, a UE may be in an urban canyon environment with large numbers of nearby devices during the day, which can present positioning challenges based on both signal reception and interference. However, the positioning environment for the same area may differ at night if there are significantly fewer proximate devices. In another example, a UE in one indoor environment may experience different challenges than if it were located in the same or a nearby building, because of different physical characteristics of the environment (e.g., differences that affect absorption/reflection of RF signals), different proximity to positioning signal transmitters, and/or location on a different floor.

Artificial Intelligence/Machine Learning (AI/ML) techniques may provide enhanced positioning performance in some challenging environments, either by itself or in addition to other positioning techniques. In AI/ML positioning, a UE or other device applies one or more AI/ML models to position-related inputs (e.g., sensor measurements and/or signal measurements) and obtain position-related output. When a machine learning model is available for an area, AI/ML positioning can provide substantially improved performance in non-line of sight (NLOS) conditions where few or no LOS signals are available for traditional positioning techniques. However, since AI/ML positioning models can be site/area specific, their advantages may be limited outside specific regions.

Managing AI/ML positioning with UE mobility across different regions/areas presents a number of challenges in the context of existing systems and processes. For example, the current LTE Positioning Protocol (LPP) specification provides for one-way signaling of area information from the network to the UE, and the UE is passive except for providing its capability for storing assistance information (in terms of a maximum number of areas). Further, the area information for assistance data is generated at the network side and with no provision for UE defining area information or indicating support for AI/ML positioning in a particular area. Instead, the UE provides information of its capacity to store assistance information and the network defines and signals information about the area.

The current disclosure provides techniques for area-specific positioning, with example implementations that can overcome existing challenges. According to some examples, area information can be defined by the network and/or the UE, which provides additional flexibility and allows more granular area information for techniques that vary according to whether the UE is in a particular area. Further, the current disclosure provides techniques for a UE to notify the network of support for area-specific positioning and for either the UE or the network to activate area-specific positioning, based on a position of the UE, a current time, or both. The techniques also allow for bi-directional signaling options for efficient cooperation between the network and UE.

In some currently available positioning methods, the network can provide some area-related identification; however, the area initiation and identification is one way (network to device) rather than bi-directional, and the UE's role is passive. For cellular positioning techniques like TDoA, multi-RTT, and AoD, a network device can provide a list of TRPs associated with an area in which assistance data is valid, but the network does not provide specific geospatial coordinates for the area. Additionally, the UE can notify the network of the maximum number of areas corresponding to cell IDs for which it can store/manage assistance data, but does not transmit information about its ability to use area-specific positioning in any particular area.

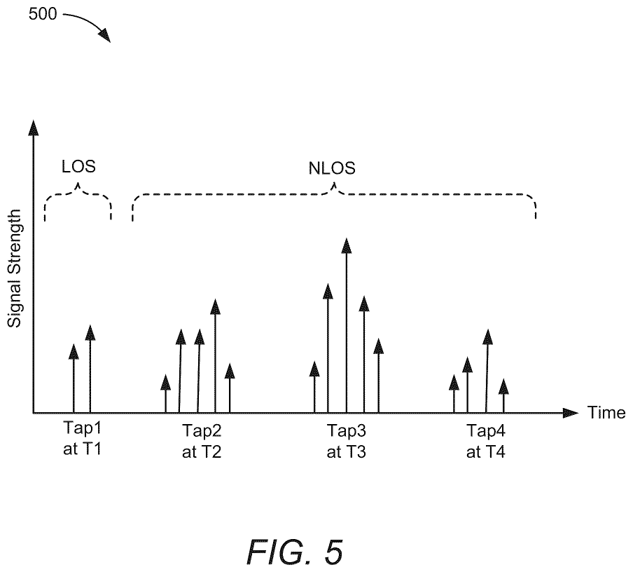

FIG. 9 shows an illustration of an example network region 900 according to some currently described positioning techniques, where the network notifies UEs that assistance information is available for an area, where the area has an area identifier (Area ID) and a list of TRPs included in the area. An area identifier (AreaID) was introduced to let LMF provide different assistance data for different areas.

According to some existing techniques, a network entity 906 (e.g., a location server implementing LMF functionality) can transmit an AreaID-CellList information element (IE) that includes a list of cell identifier fields (nr-CellGlobalID or nr-PhysCellID) for one or more TRPs associated with the AreaID. In the example of FIG. 9, network entity 906 can transmit AreaID-Cell List IEs for areas 930-1 to 930-6, listing a cell identifier of the included TRPs, up to a maximum number of cell identifiers MaxCellIDsPerArea. For example, the list for area 930-1 would include the global or physical cell ID for TRPs 904-1, 904-2, and 904-3.

In addition to the AreaID-CellList IE, network device 906 can transmit assistance data for one or more of areas 930-1 to 930-6 to UE 902 to be used for positioning within the area. UE 902 can notify the network of its capacity for storing assistance information; for example, using a maxNrofAreas field in a provide capabilities IE. Network device 906 can limit transmission of assistance data to conform to the UE capacity as UE 902 traverses a path 903.

Although the AreaID-CellList provides the UE with an indication of one or more areas, the existing process does not have support for geospatial coordinate (latitude/longitude/altitude) indication or temporal validity of a particular area. Additionally, current techniques signal one area listing at a time, which can limit the types of area definition. Further, the network defines the areas and indicates the area listing to the UE, with no bi-directional communication of area definitions and area-specific capability. Finally, areas are identified only by the network, with no mechanism for a UE to initiate area definition or define geographic or temporal aspects of the area(s).

In another currently described technique, a network device can provide assistance data for barometric pressure sensing, which can be used to determine UE elevation. The assistance data includes reference pressure at a reference temperature that is indicated to be valid in a validity area for a validity period, and the UE indicates its capability to perform barometric pressure sensing to the network. Although this technique does describe an area using geospatial coordinates and a validity period, the sensing itself is not area-specific; instead, the assistance data is related to current environmental conditions in the area and calibrates the on-board sensor data.

The current disclosure provides techniques for area definition, as well as bi-directional signaling that can be used for area-specific positioning. In particular, AI/ML techniques that use area-specific models can benefit from signaling between the UE and network regarding area information.

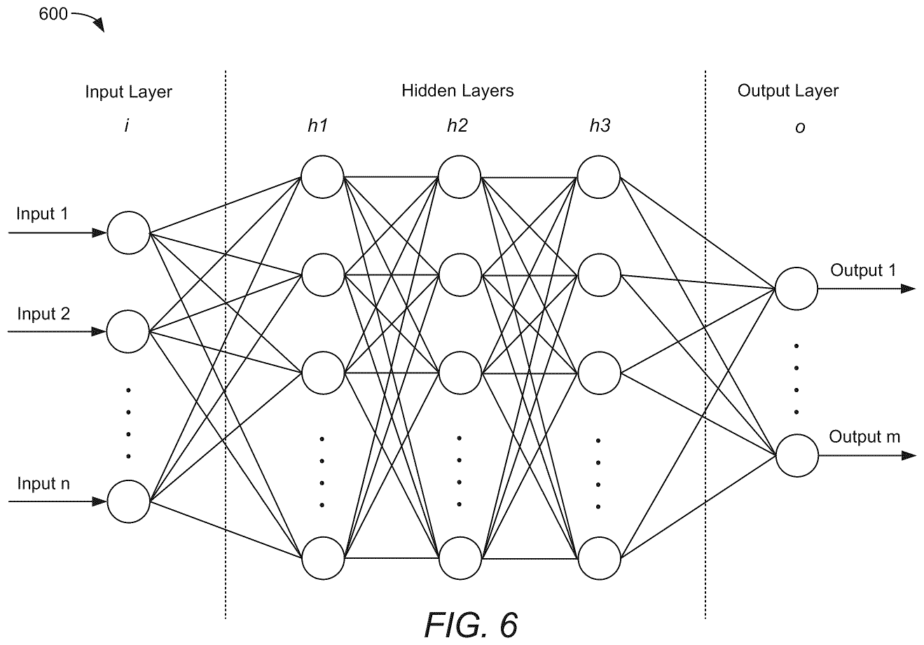

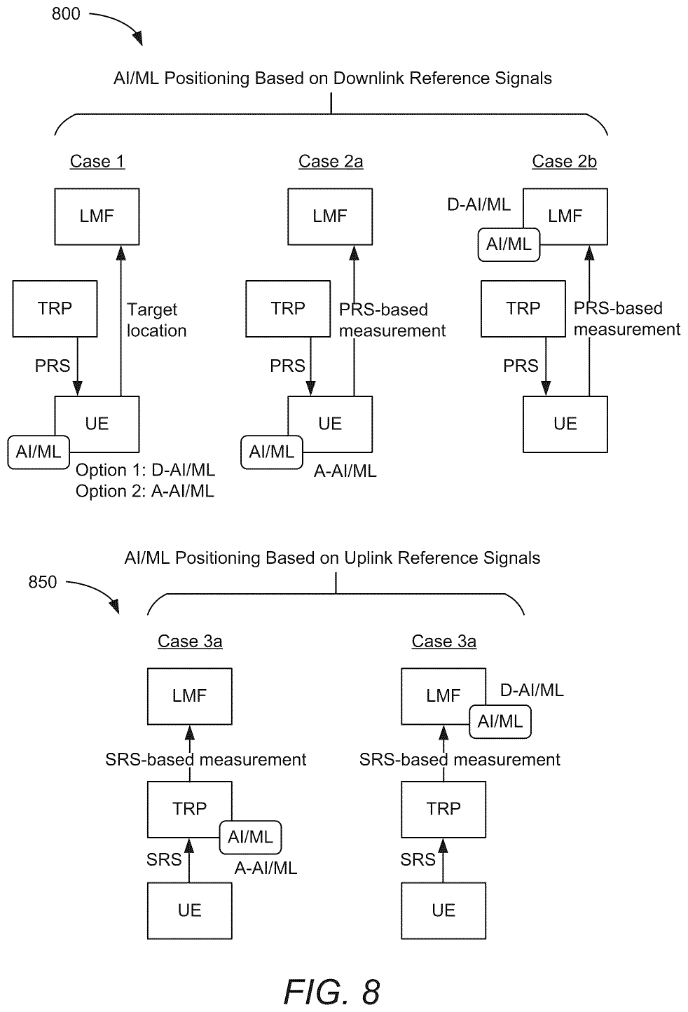

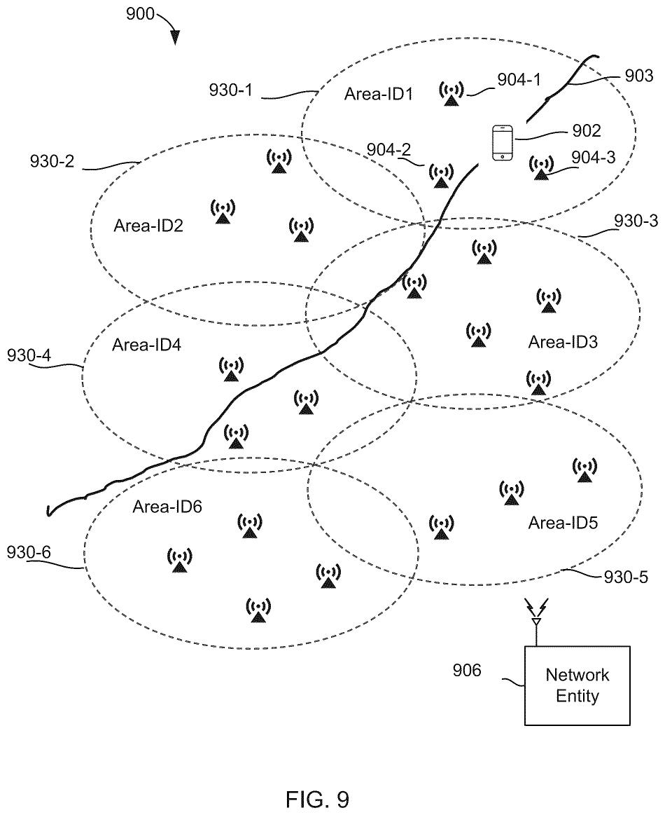

FIG. 10 shows a network region 1000 illustrating example areas that can be identified and described according to implementations of the current disclosure. The example of FIG. 10 shows both UE-initiated areas and network-initiated areas, and an example path 1003 that UE 1002 could traverse through different areas. A UE-initiated area is one where the definition of an area is initiated by the UE. The area definition itself (e.g., determination of one or more locations in the area, a span of the area, area timing parameters, etc.) may be done entirely by the UE, or it may be accomplished with cooperation between the UE and the network. Examples are described below with reference to FIG. 12. Further, the UE can assign an area ID for UE-initiated areas, or it can be assigned in cooperation with the network. Similarly, a network-initiated area is one where the definition of the area is initiated by the network. Examples of network-initiated area techniques are described below with reference to FIG. 13.

As outlined in further detail below, some area information for each type of area may be provided or updated by the other type of device; for example, an area description for a network-initiated area may have one or more associated timing parameters based on information received from a UE. In another example, the network may assign identifiers for both types of areas, so although the UE initiates a particular area, the area identifier assignment can be done by the network.

Example network region 1000 includes seven network-initiated areas 1030-1 to 1030-7 and four UE-initiated areas 1035-1 to 1035-4 (with area 1035-1 having three non-contiguous portions). In FIG. 10, areas 1030-1 to 1030-7 and 1035-1 to 1035-4 each have an area identifier and can be described with area information that indicates the position/span of the area (and optionally time parameters for the area). In FIG. 10, the example identifier for network-initiated areas has the format Area-ID [integer], while the example identifier for UE-initiated areas has the format Area-IDU [integer]. In practice, areas identified by different entities can share a set of possible identifiers or they may differ according to the initiating entity, as shown in FIG. 10. Further, the format of the identifiers may be different than the examples herein.

Areas 1030-1 to 1030-6 are similar to areas 930-1 to 930-6 of FIG. 9, but can be associated with geospatial parameters rather than (or in addition to) a list of cellular IDs. For example, area 1030-1 may be described in terms of geospatial parameters and additionally by cellular IDs for TRPs 1004-1, 1004-2, and 1004-3. The geospatial parameters can include latitude information, longitude information, altitude information, or a combination thereof. Area information for areas 1030-1 to 1030-7 and 1035-1 to 1035-4 can include coordinates for a center or other point for the area, and can include information related to a span of the area such as a radius for a circular area, coordinates for or a vector towards one or more particular points of a polygonal area, ellipse, or other geospatial indicator of the span of an area. If area shapes and/or spans are pre-defined, the area information may indicate which of a pre-defined shape and/or span is associated with the area.

The network-initiated area 1030-7 (associated with Area ID-7) is an example of an area that is included partially or fully within one or more other areas (in this case, a network-initiated area fully included in another network-initiated area). An included area can be used for differentiating among different positioning environments, positioning requirements, UE capabilities, etc. For example, the UE may support AI/ML positioning for a particular machine learning model in larger area 1030-6 (including area 1030-7), but also support a different machine learning model for area 1030-7. Network entity 1006 may determine to activate the machine learning model for UE 1002 in area 1030-6, and upon a determination that UE 1002 is positioned in area 1030-7 may leave the same machine learning model in operation or change to the different machine learning model.

Although the example shown in FIG. 10 illustrates a flat organization of areas, in some examples described herein, hierarchical organization of multiple area listings can be used, described in more detail below. Multiple area listings can help indicate different positioning capabilities, including generalization, performance, complexity, reporting, etc.

According to some aspects of the current disclosure, UE 1002 can receive area information for one or more of the areas 1030, the area information including area identifiers (IDs) of the one or more areas, an area description of the one or more areas, or both. The area information can be provided by the network entity 1006.

The area information for the areas can include geospatial coordinates for a center, vertex/vertices or other point(s) (such as latitude, longitude, and/or elevation), assigned coordinates (such as an address, interior room number, floor number, etc.), area span information (such as area radius, distance to one or more vertices, address range, floor range, etc) or other information that identifies the area. As illustrated in FIG. 10, in some implementations, the areas need not have the same size or shape, can overlap with each other and/or with network-identified areas, need not be contiguous, and need not include any TRPs. For example, network-identified area 1030-7 is smaller than the other network-identified areas, and the UE-identified areas have different sizes and shapes. Area 1035-1 includes three non-contiguous segments, and network-initiated area 1030-7 does not include a TRP. UE-initiated area 1035-1 overlaps network-initiated areas 1030-2 and 1030-3, with one segment overlapping a part of each of the two network-initiated areas.

An implementation according to the current disclosure can provide flexible and accurate area-specific positioning. Existing techniques using cell IDs can be problematic since their mapping to existing TRP anchors can change over time (e.g., as part of network redeployment, planning, or enhancement), so cell ID based area definition may need to be updated as a result of network changes. Even when network mapping is up-to-date, the current techniques may provide more accurate and granular support for area-specific positioning.

In some implementations, area listings can be organized to enable more flexibility and efficiency in positioning. Each listing can be assigned an area listing identifier (ID), and can be arranged in a hierarchy. Multiple area listings can be active or indicated at the same time. Further, area listings can have overlapping definitions (e.g., overlapping cell IDs/geospatial information/timing parameters). Multiple area listings can help indicate different positioning capabilities, including generalization, performance, complexity, reporting, etc. In some examples, area listings can be initiated and defined by one or more UEs, by the network, or both, similar to the initiation and identification of areas described in more detail below.

In general, a hierarchy of area identification can be represented by multiple IDs that represent different levels of the hierarchy. For example, an identification with three available levels of hierarchy can be represented by a multi-part ID with three parts: [GroupID][SubgroupID][ItemID]. The groupings can be based on geographic factors, positioning-related factors, environmental factors, initiating entity, etc. For example, an area listing may be based on whether an area is network-initiated or UE-initiated, so that a multi-part ID would include a first portion identifying the initiating entity type and a second portion identifying the area within that grouping. Similarly, an area listing may span a number of larger areas, each of which can be associated with one or more smaller sub-areas, with a multi-part ID identifying the larger area in a first portion and the particular sub-area within the larger area in a second portion. As with any of the example formats herein, the order of the identifier or particular format is optional (e.g., portions are designated first and second for ease of discussion but need not be in any particular order for a compound identifier).

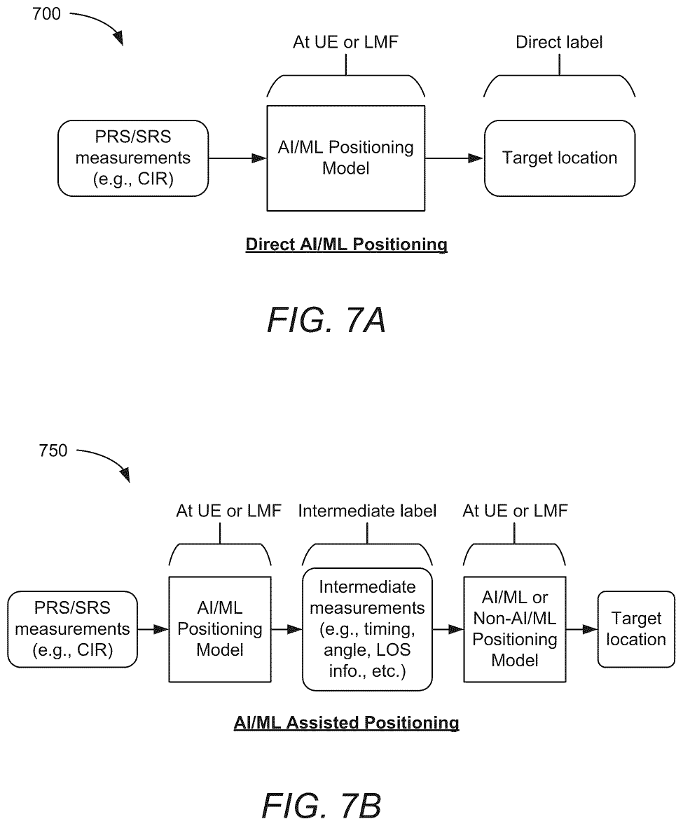

FIG. 11 shows an example configuration 1100 of hierarchically organized areas, according to one or more aspects of the disclosure, and an example path 1103 that UE 1102 could traverse through different areas. In the example shown, different levels are given different area listing identifiers (IDs) (a type of GroupID), and the different areas of that level have an area identifier (a type of ItemID). Areas may be initiated by a UE such as UE 1102, or by a network entity such as network entity 1106, and identifiers can be associated with the areas and area listings by either type of entity. In the example of FIG. 11, areas 1130-1 to 1130-6 are part of a first level with an area listing identifier List-ID1, with each of the six areas having area identifiers Area-ID1 to Area-ID6. Areas 1138-1 and 1138-2 are part of a second level with an area listing identifier List-ID2, with the two areas having Area-ID1 and Area-ID2. Any area of FIG. 11 can be specified with an area ID that has a first portion identifying the area listing (List-ID), and a second portion identifying an area within the area listing (Area-ID), resulting in a combined identifier of the format List-ID-Area-ID. Like the implementation described above with reference to FIG. 10, different formats may be used for identifiers. Additionally, the areas need not be the same size, can overlap, need not be contiguous, need not include any TRPs, etc. Further, more than two levels of hierarchy can be used.

In another implementation of the current disclosure, indication of one or more timing parameters can be used in addition to area indication for some area-specific positioning. For example, an area's characteristics can differ over time in a way that makes a machine learning model more or less accurate, so different models can be used at different times, or the UE can change to a different positioning type based on a machine learning validity time indication. In order to reflect this possible difference, timing parameters can be used for AI/ML positioning. An area timing parameter can be an area validity timer, a range or area validity timing, start time, end time, or other timing parameter. Area timing parameters can be expressed in terms of a global timing indicator such as UTC time or a network timing indicator such as hyperframe number, frame number, OFDM symbol number etc.

Timing indication need not be constricted to contiguous time intervals; non-contiguous timing information such as multiple time ranges, periodicity, or other non-contiguous intervals can be indicated and applied. In some implementations, non-contiguous timing information can be indicated using a start time indication, an end time indication, a duration indication, a periodicity indication, or some combination.

As described above, an area can be initiated by the network or by a UE. FIG. 12 shows an example method 1200 for a UE-initiated area, according to one or more aspects of the disclosure. At 1210, a UE transmits an indication of area initiation. For example, the UE may be capable of AI/ML positioning and may initiate an area as part of training and/or using a machine learning model in an area proximate the current position of the UE. Although the UE does not need to define an area in order to use AI/ML positioning, using the techniques described herein allows the network to coordinate with the UE for accurate and efficient positioning given the available positioning methods and the UE positioning environment and needs.

The indication may be a message identifying one or more UE-initiated areas. UE can include an area ID, area description, capability information, or a combination in the initial indication (implicitly or explicitly), or some information can be provided in subsequent signaling. For example, in some implementations, the indication of area initiation to the network can serve as an indication of support for AI/ML positioning in the area, while in some implementations the UE will explicitly indicate support in the initial signaling or in a later message. Similarly, area information can be managed in a number of ways.

At 1220, the UE may transmit at least some area description, as part of the initial indication and/or in later signaling. For example, the initial indication may explicitly indicate at least a portion of an area description such as geospatial coordinates for at least one location in the area, an indication of the span of the area, one or more timing parameters for the area, or a combination thereof. In some implementations, at least some of the area information may be pre-defined; for example, UE-initiated areas may have a pre-defined shape or size, or the UE may indicate a shape and/or size from pre-defined alternatives. In some implementations, the indication itself may serve as an implicit indication of at the least some area information; for example, the network may use the location of the UE at the time of the indication as a part of the area description.

Additional area information may be provided UE, and the UE may receive additional area information from the network, if available. For example, the UE may transmit and/or receive timing information for the area, where the timing information includes one or more timing parameters during which area-specific positioning is supported in the area. The UE may also transmit and/or receive additional or updated information describing the position or span of the area, if appropriate.

At 1230, the UE or the network may assign an area ID to the area. For example, the UE may transmit an area ID with the indication of area initiation or in other signaling, or may receive the area ID from the network. In implementations using multiple area listings with associated area listing IDs, the area may be associated with an area ID as well as one or more area listing IDs.

At 1240, the UE may transmit an indication of support for area-specific positioning in the area, if the indication was not included in an earlier communication, or if the support has been updated. In some cases, UE area initiation can serve as an implicit indication of support for the area-specific positioning.

Areas can also be initiated by the network. FIG. 13 shows an example method 1300 for a network-initiated area, according to one or more aspects of the disclosure. At 1310, the network may determine area information for one or more areas. The area information can include for example, geospatial coordinates for at least one location in the area, an indication of the span of the area, one or more timing parameters for the area, or a combination thereof. At 1320, the network can also assign an area ID to the area. Once the area is at least partially defined, at 1330, the network entity may transmit area information to one or more UEs; for example, if a UE is positioned in or proximate to one or more of the network-initiated areas. The area information can include area description, area ID, or both. At 1340, the network can optionally transmit additional area information and/or receive additional area information from a UE. For example, the network can receive timing parameter(s) for the area from the UE, where the timing parameters indicate one or more time ranges in which area-specific positioning is supported in the area.

The current disclosure may also provide for bi-directional signaling to initiate, switch, or discontinue different positioning techniques. For example, the UE can indicate its support for an area-specific positioning type in one or more areas, whether the areas have been identified by the network or by the UE (and/or other devices). A network entity can activate or deactivate area-specific positioning (e.g., AI/ML positioning) based on UE entry or exit of a specific area, and indicate the availability of assistance information for specific areas.

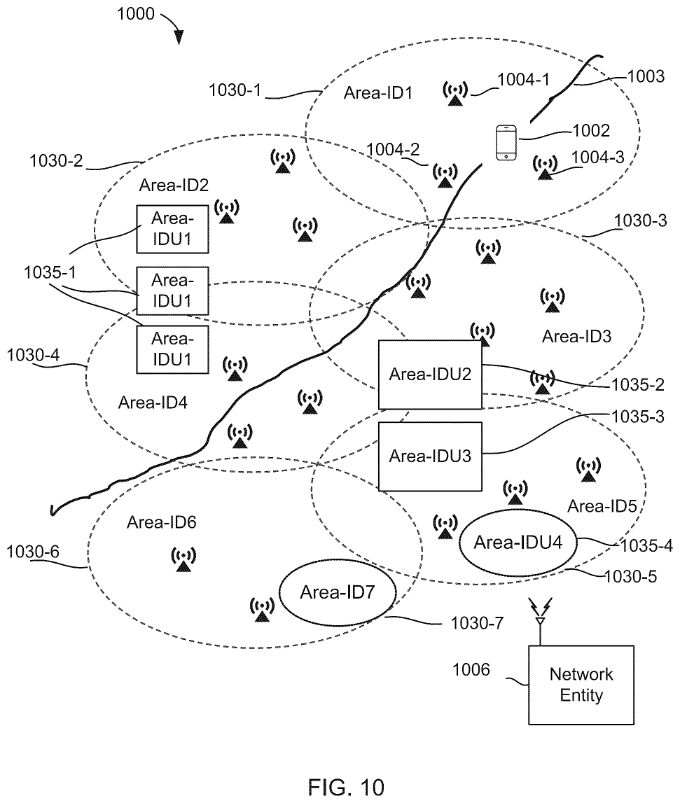

FIG. 14 shows an example area-specific positioning method 1400 implemented at a user equipment, according to some aspects of the current disclosure. At 1410, a UE can determine that it is located in (or proximate to) one or more areas, or it can receive an indication from a network entity, and may also determine or receive an indication that area-specific positioning is supported for a current time. The one or more areas may include UE-initiated area(s) and/or network-initiated area(s). At 1420, the UE can transmit an indication of its capability to perform area-specific positioning such as AI/ML positioning for at least one of the one or more areas, if appropriate. For example, the UE can transmit an indication of its capability to perform area-specific positioning without network request, or in response to a request from the network.

At 1430, the UE can perform area-specific positioning, either based on its determination to do so or in response to an indication from the network to do so. For example, the UE can perform the area-specific positioning in response to a position of the UE, a current time, or both. To perform AI/ML positioning, the UE can obtain one or more measurements of one or more reference signals and apply a machine learning model to the one or more measurements to obtain area-specific positioning information. In some implementations, the one or more measurements can include sensing measurements, positioning measurements or both. At 1440, the UE can transmit the area-specific positioning information to the network for use in position determination. In some examples, the area-specific positioning information is used with other positioning techniques to determine the UE position.

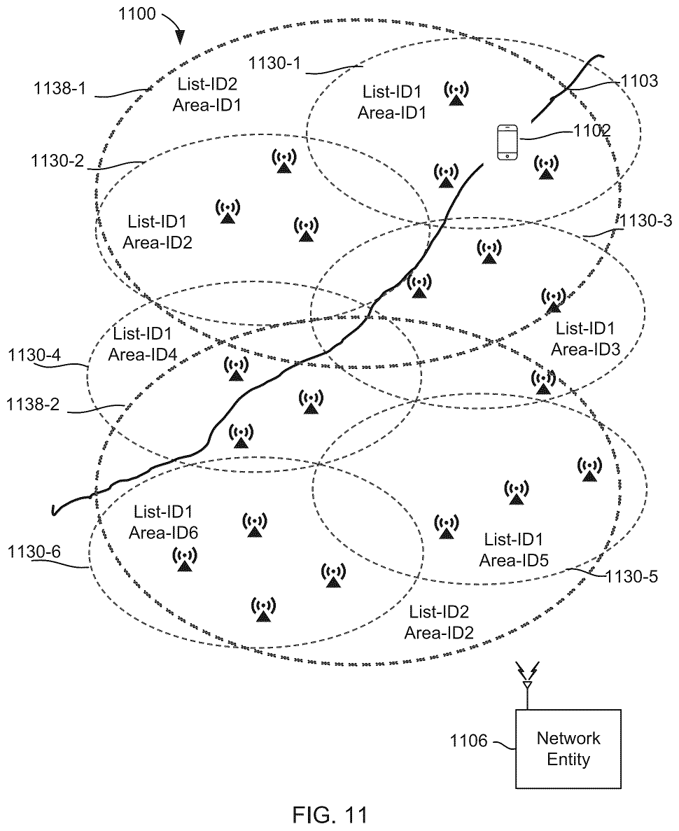

FIG. 15 shows an example area-specific positioning method 1500 implemented at a network entity, according to some aspects of the current disclosure. At 1510, a network entity can indicate to UE that UE is located in (or proximate to) one or more areas. The one or more areas may include UE-initiated area(s) and/or network-initiated area(s). The indication may include area information including one or more area IDs, area description, or both. At 1520, the network entity can request UE indicate its capability to perform area-specific positioning such as AI/ML positioning, for at least one of the one or more areas, if the network does not have the capability information or if a capability update is appropriate.

For a UE with sufficient capability (including support of the area-specific positioning at a current time, if timing parameters are associated with the first area) and positioned in or proximate to a first area of the one or more areas, at 1530, the network can instruct the UE to perform area-specific positioning. For AI/ML positioning, the UE can obtain one or more measurements of one or more reference signals and apply a machine learning model to the one or more measurements to obtain area-specific positioning information. In some implementations, the one or more measurements can include sensing measurements, positioning measurements or both. At 1540, the network entity can receive the area-specific positioning information from the UE. In some implementations, capability signaling and/or other parts of the current techniques are applied when the UE is in a supported area (such as the first area), while in some implementations, some actions can be performed when the UE is proximate to a supported area. For example, proximity for capability signaling or for indication/instruction to perform area-specific positioning may be determined when a UE is within a particular distance from a supported area, or if route prediction indicates that area-specific positioning can be used along a current route of the UE.

According to some implementations, the network or UE can activate or deactivate area-specific (e.g., AI/ML) positioning for an area, switch from one machine learning model to another, and/or select and switch to a particular different positioning technique or a fallback technique. For example, the UE can perform area-specific positioning at a first time. The area-specific positioning can be activated by the UE, by the network without UE input, or by the network in response to a trigger from the UE. At a subsequent time, the UE can deactivate the area-specific positioning, switch to a different machine learning model (for AI/ML positioning), use a different positioning technique, switch to a fallback positioning technique, or a combination. The UE can determine to change positioning, the network can determine to make the change without UE input, or the network can determine to make the change in response to a trigger from the UE.

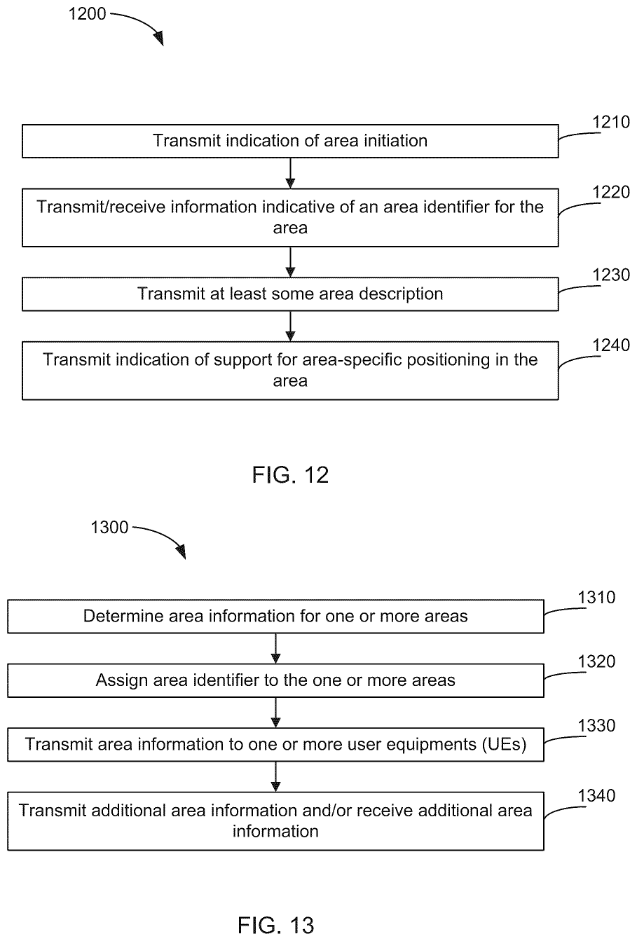

FIG. 16 illustrates an example method 1600 of wireless communication, according to aspects of the disclosure. In an aspect, method 1600 can be performed by a UE (e.g., UE 302 of FIG. 3A). At 1610, the UE may receive area information for one or more areas, the area information including area identifiers (IDs) of the one or more areas, an area description of the one or more areas, or both. In some implementations, operation 1610 can be performed, for example, using WWAN transceiver(s) 310, short range transceiver(s) 320, processor(s) 332, memory 340, and/or positioning component(s) 342 of UE 302, which may be considered means (structure) for performing operation 1610. The area information for each of the one or more areas can include an associated area description including geospatial parameters, timing parameters, or both. FIGS. 12 and 13 and the associated description provide more details about area initiation. Geospatial parameters can include latitude information, longitude information, altitude information, or a combination thereof, and timing parameters can include area validity timer information, validity timing range information, validity start time, validity end time, or a combination thereof.

At 1620, the UE may transmit an indication of support for area-specific positioning in at least a first area of the one or more areas. Note that “first” in this context is used for convenience to designate a particular area and does not designate a preference for the area or a need for a second or other additional area. In some implementations, operation 1620 can be performed, for example, using WWAN transceiver(s) 310, short range transceiver(s) 320, processor(s) 332, memory 340, and/or positioning component(s) 342 of UE 302, which may be considered means (structure) for performing operation 1620.

A technical advantage of method 1600 is communication of area information between UEs and the network to facilitate efficient area-specific positioning. In particular, method 1600 can be used with AI/ML positioning, where identification of supported areas may be important.

For AI/ML positioning, the UE or network can activate positioning in the first area based on a position of the UE, a current time, or both. The UE can perform the area-specific positioning by obtaining one or more measurements of one or more reference signals in the first area; and performing the area-specific positioning in the first area using the one or more measurements of the one or more reference signals. FIGS. 14 and 15 and the associated description include further details of area-specific positioning, while FIGS. 12 and 13 and the associated description include further details of area initiation.

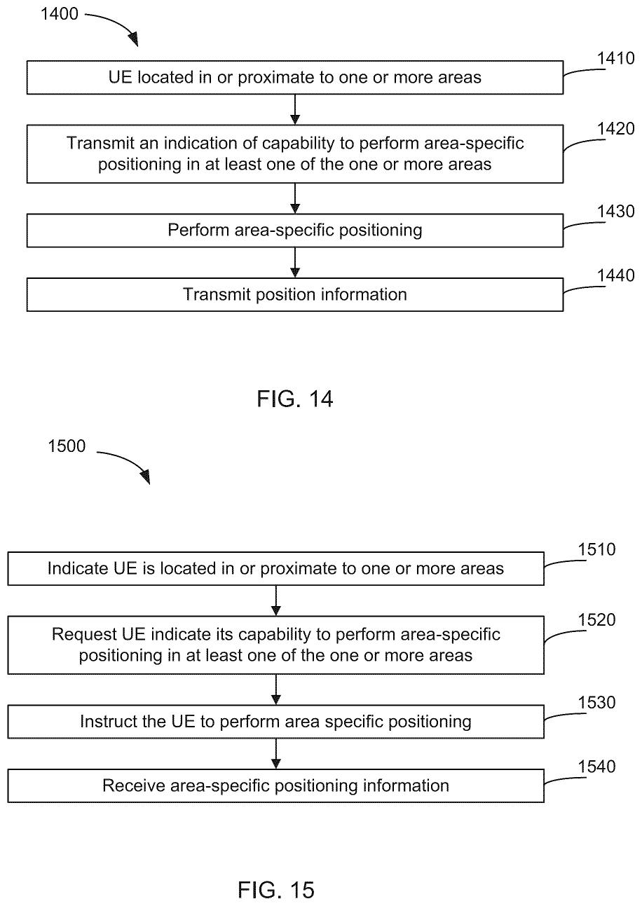

FIG. 17 illustrates an example method 1700 of communication, according to aspects of the disclosure. In an aspect, method 1700 can be performed by a UE (e.g., UE 302 of FIG. 3A). At 1710, a UE can transmit a message identifying one or more UE-initiated areas, where the message includes an area ID, area description, or both for one or more UE-initiated areas. In some implementations, operation 1710 can be performed, for example, using WWAN transceiver(s) 310, short range transceiver(s) 320, processor(s) 332, memory 340, and/or positioning component(s) 342 of UE 302, which may be considered means (structure) for performing operation 1710. The message can include an area description for the one or more UE-initiated areas, wherein the area description includes geospatial parameters, timing parameters, or both. FIGS. 14 and 15 and the associated description include further details of area-specific positioning, while FIGS. 12 and 13 and the associated description include further details of area initiation.

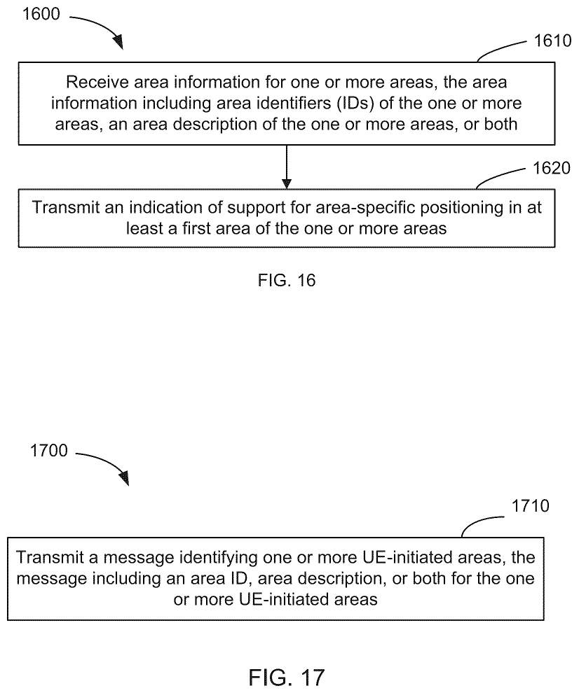

FIG. 18 illustrates an example method 1800 of wireless communication, according to aspects of the disclosure. In an aspect, method 1800 can be performed by a network entity (e.g., a RAN node, such as ng-eNB 224 or gNB 222 as shown in FIG. 2B or a base station 304 of FIG. 3B, or a location server, such as an LMF 270 of FIG. 2 or network entity 306 of FIG. 3C). At 1810, a network entity can transmit area information for one or more areas to a user equipment (UE), the area information including area identifiers (IDs) of the one or more areas, an area description of the one or more areas, or both. In an aspect, operation 1810 can be performed by network transceiver(s) 398, memory 396, processor(s) 394, and/or positioning component 398 of network entity 306 in cooperation with network transceiver(s) 380, memory 386, processor(s) 384, WWAN transceiver(s) 350, short-range wireless transceiver(s) 360, and positioning component(s) 388 of base station 304. At 1820, a network entity can receive an indication of support for area-specific positioning in at least a first area of the one or more areas. In an aspect, operation 1820 can be performed by network transceiver(s) 398, memory 396, processor(s) 394, and/or positioning component 398 of network entity 306 in cooperation with network transceiver(s) 380, memory 386, processor(s) 384, WWAN transceiver(s) 350, short-range wireless transceiver(s) 360, and positioning component(s) 388 of base station 304. FIGS. 14 and 15 and the associated description include further details of area-specific positioning, while FIGS. 12 and 13 and the associated description include further details of area initiation.

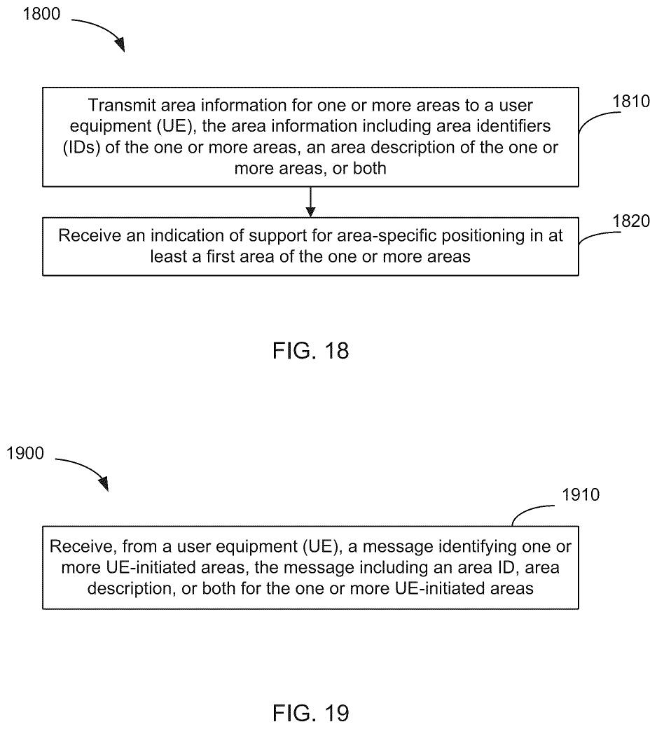

FIG. 19 illustrates an example method 1900 of communication, according to aspects of the disclosure. In an aspect, method 1900 can be performed by a network entity (e.g., a RAN node, such as ng-eNB 224 or gNB 222 as shown in FIG. 2B or a base station 304 of FIG. 3B, or a location server, such as an LMF 270 of FIG. 2 or network entity 306 of FIG. 3C). At 1910, a network entity can receive, from a user equipment, a message identifying one or more UE-initiated areas, the message including an area ID, area description, or both for the one or more UE-initiated areas. In an aspect, operation 1910 can be performed by network transceiver(s) 398, memory 396, processor(s) 394, and/or positioning component 398 of network entity 306 in cooperation with network transceiver(s) 380, memory 386, processor(s) 384, WWAN transceiver(s) 350, short-range wireless transceiver(s) 360, and positioning component(s) 388 of base station 304. FIGS. 14 and 15 and the associated description include further details of area-specific positioning, while FIGS. 12 and 13 and the associated description include further details of area initiation.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of wireless communication at a user equipment (UE) comprising: receiving area information for one or more areas, the area information including area identifiers (IDs) of the one or more areas, an area description of the one or more areas, or both; and transmitting an indication of support for area-specific positioning in at least a first area of the one or more areas.
Clause 2. The method of clause 1, further comprising: obtaining one or more measurements of one or more reference signals in the first area; and performing the area-specific positioning in the first area using the one or more measurements of the one or more reference signals.
Clause 3. The method of any of clauses 1 to 2, wherein the area information for each of the one or more areas includes an associated area description including geospatial parameters, timing parameters, or both.
Clause 4. The method of clause 3, wherein the geospatial parameters include latitude information, longitude information, altitude information, or a combination thereof.
Clause 5. The method of any of clauses 3 to 4, wherein the timing parameters include area validity timer information, validity timing range information, validity start time, validity end time, or a combination thereof.
Clause 6. The method of any of clauses 3 to 5, wherein the timing parameters are expressed using coordinated universal time (UTC), hyper frame number, frame number, orthogonal frequency division multiplexing (OFDM) symbol number, or a combination thereof.
Clause 7. The method of any of clauses 3 to 6, wherein the timing parameters include at least some non-contiguous timing information.
Clause 8. The method of clause 7, wherein the non-contiguous timing information includes at least one indication selected from a group consisting of: a start time indication, an end time indication, a duration indication, and a periodicity indication.
Clause 9. The method of any of clauses 1 to 8, wherein the one or more areas are network-initiated areas, and further comprising: transmitting a message identifying one or more UE-initiated areas.
Clause 10. The method of clause 9, wherein at least one of the one or more UE-initiated areas partially or fully overlaps at least one of the one or more areas.
Clause 11. The method of any of clauses 1 to 10, wherein the area-specific positioning comprises Artificial Intelligence/Machine Learning (AI/ML) positioning.
Clause 12. The method of clause 11, further comprising: obtaining one or more measurements of one or more reference signals in the first area; and applying a machine learning model to the one or more measurements of one or more reference signals in the first area to obtain area-specific positioning information.
Clause 13. The method of clause 12, further comprising: applying the machine learning model to the one or more measurements of one or more reference signals in response to a position of the UE, a current time, or both.
Clause 14. The method of clause 13, further comprising: at a subsequent time, determining to: deactivate AI/ML positioning for the machine learning model, apply a different machine learning model to the one or more measurements, select a different positioning technique, switch to a fallback positioning technique, or a combination thereof.
Clause 15. The method of any of clauses 12 to 14, further comprising: receiving an indication to perform AI/ML positioning; and wherein applying the machine learning model to the one or more measurements is in response to the indication to perform AI/ML positioning.
Clause 16. The method of clause 15, further comprising: subsequent to receiving the indication to perform AI/ML positioning, receiving an indication to deactivate AI/ML positioning.
Clause 17. The method of clause 16, further comprising: transmitting an indication to a network entity to initiate deactivation of the AI/ML positioning; and wherein the indication to deactivate AI/ML positioning is received in response to the transmitting.
Clause 18. The method of any of clauses 15 to 17, further comprising: subsequent to receiving the indication to perform the AI/ML positioning, receiving an indication to switch to a different positioning method.
Clause 19. The method of clause 18, wherein the indication to switch to the different positioning method is an indication to switch to a fallback positioning method.
Clause 20. The method of any of clauses 18 to 19, further comprising: transmitting an indication to a network entity to initiate the switch to the different positioning method; and wherein the indication to switch to the different positioning method is received in response to the transmitting.
Clause 21. The method of any of clauses 15 to 20, further comprising: subsequent to receiving the indication to perform AI/ML positioning, receiving an indication to switch to a different machine learning model.
Clause 22. The method of clause 21, wherein the indication to switch to the different machine learning model comprises an indication that the UE is in or proximate to a different area than the first area, and wherein the UE supports AI/ML positioning in the different area.
Clause 23. The method of any of clauses 21 to 22, further comprising: transmitting an indication to a network entity to initiate the switch to the different machine learning model; and wherein the indication to switch to the different machine learning model is received in response to the transmitting.
Clause 24. The method of any of clauses 11 to 23, wherein transmitting an indication of support for area-specific positioning in at least the first area of the one or more areas is in response to a request for a capability of the UE to perform AI/ML positioning.
Clause 25. The method of any of clauses 12 to 24, wherein the one or more measurements include sensing measurements or positioning measurements or both.
Clause 26. The method of any of clauses 1 to 25, wherein the area information for the first area includes an area description, the area description including timing information indicating one or more time ranges during which area-specific positioning is supported in the first area.
Clause 27. The method of clause 26, further comprising: determining to perform the area-specific positioning in the first area based at least in part on determining that a current time is included in the one or more time ranges.
Clause 28. The method of any of clauses 26 to 27, wherein the timing information includes validity timer information, range of area validity timing information, periodic validity time information, or a combination thereof.
Clause 29. The method of any of clauses 1 to 28, further comprising: determining that the UE is located in or proximate to the first area; and performing the area-specific positioning in the first area in response to the determining.
Clause 30. The method of any of clauses 1 to 29, further comprising: receiving an instruction to perform the area-specific positioning in the first area based on a position of the UE, a current time, or both; and performing the area-specific positioning in the first area in response to the instruction.
Clause 31. The method of any of clauses 1 to 30, wherein the area information for the one or more areas includes an area ID for each of the one or more areas, wherein the area IDs for the one or more areas include a first portion identifying an area listing and a second portion identifying an area within the area listing.
Clause 32. The method of clause 31, wherein the first portion identifying the area listing identifies whether the area is network-initiated or UE-initiated.
Clause 33. The method of any of clauses 1 to 32, wherein the area information for the one or more areas includes an area ID for each of the one or more areas, wherein the area IDs for the one or more areas include a plurality of portions each associated with a hierarchy level, the plurality of portions including a group identifier associated with an area listing having a first hierarchy level, a subgroup identifier identifying an area listing having a second hierarchy level, and an item identifier identifying the area at a third hierarchy level.
Clause 34. A method of wireless communication at a user equipment (UE) comprising: transmitting a message identifying one or more UE-initiated areas, the message including an area identifier (ID), area description, or both for the one or more UE-initiated areas.
Clause 35. The method of clause 34, wherein the message includes an area description for the one or more UE-initiated areas, wherein the area description includes geospatial parameters, timing parameters, or both.
Clause 36. The method of any of clauses 34 to 35, wherein the message includes an area ID for each of the one or more UE-initiated areas, and wherein at least one of the one or more UE-initiated areas includes a plurality of non-contiguous area segments associated with a same area ID.
Clause 37. The method of any of clauses 34 to 36, further comprising: performing area-specific positioning in a first area of the one or more UE-initiated areas.
Clause 38. The method of clause 37, wherein the area-specific positioning is AI/ML positioning, and wherein performing area-specific positioning in the first area comprises: obtaining one or more measurements of one or more reference signals; and applying a machine learning model to the one or more measurements of the one or more reference signals in the first area to obtain area-specific positioning information.
Clause 39. A method of communication at a network entity comprising: transmitting area information for one or more areas to a user equipment (UE), the area information including area identifiers (IDs) of the one or more areas, an area description of the one or more areas, or both; and receiving an indication of support for area-specific positioning in at least a first area of the one or more areas.
Clause 40. The method of clause 39, wherein the area information for each of the one or more areas includes an associated area description including geospatial parameters, timing parameters, or both.
Clause 41. The method of clause 40, wherein the geospatial parameters include latitude information, longitude information, altitude information, or a combination thereof.
Clause 42. The method of any of clauses 40 to 41, wherein the timing parameters include area validity timer information, validity timing range information, validity start time, validity end time, or a combination thereof.
Clause 43. The method of any of clauses 39 to 42, wherein the one or more areas are network-initiated areas, and further comprising: receiving a message identifying one or more UE-initiated areas.
Clause 44. The method of any of clauses 39 to 43, wherein the area-specific positioning comprises Artificial Intelligence/Machine Learning (AI/ML) positioning, and further comprising: instructing the UE to perform the AI/ML positioning at a first time.
Clause 45. The method of clause 44, further comprising: at a second time subsequent to the first time, instructing the UE to: deactivate AI/ML positioning, switch to a different machine learning model, select a different positioning technique, switch to a fallback positioning technique, or a combination thereof.
Clause 46. The method of any of clauses 39 to 45, further comprising: determining that a UE is located in or proximate to the first area; and instructing the UE to perform the area-specific positioning in the first area in response to the determining.
Clause 47. A method of communication at a network entity comprising: receiving, from a user equipment (UE), a message identifying one or more UE-initiated areas, the message including an area identifier (ID), area description, or both for the one or more UE-initiated areas.
Clause 48. The method of clause 47, wherein the message includes an area description for the one or more UE-initiated areas, wherein the area description includes geospatial parameters, timing parameters, or both.
Clause 49. The method of any of clauses 47 to 48, further comprising: instructing the UE to perform area-specific positioning in a first area of the one or more UE-initiated areas.
Clause 50. The method of clause 49, wherein the area-specific positioning is AI/ML positioning, and further comprising: receiving positioning information from the UE, the positioning information obtained using a machine learning model.
Clause 51. A user equipment (UE), comprising: one or more memories; one or more transceivers; and one or more processors communicatively coupled to the one or more memories and the one or more transceivers, the one or more processors, either alone or in combination, configured to: receive, via the one or more transceivers, area information for one or more areas, the area information including area identifiers (IDs) of the one or more areas, an area description of the one or more areas, or both; and transmit, via the one or more transceivers, an indication of support for area-specific positioning in at least a first area of the one or more areas.
Clause 52. The user equipment of clause 51, wherein the one or more processors, either alone or in combination, are further configured to: obtain one or more measurements of one or more reference signals in the first area; and perform the area-specific positioning in the first area using the one or more measurements of the one or more reference signals.
Clause 53. The user equipment of any of clauses 51 to 52, wherein the area information for each of the one or more areas includes an associated area description including geospatial parameters, timing parameters, or both.
Clause 54. The user equipment of clause 53, wherein the geospatial parameters include latitude information, longitude information, altitude information, or a combination thereof.
Clause 55. The user equipment of any of clauses 53 to 54, wherein the timing parameters include area validity timer information, validity timing range information, validity start time, validity end time, or a combination thereof.
Clause 56. The user equipment of any of clauses 53 to 55, wherein the timing parameters are expressed using coordinated universal time (UTC), hyper frame number, frame number, orthogonal frequency division multiplexing (OFDM) symbol number, or a combination thereof.
Clause 57. The user equipment of any of clauses 53 to 56, wherein the timing parameters include at least some non-contiguous timing information.
Clause 58. The user equipment of clause 57, wherein the non-contiguous timing information includes at least one indication selected from a group consisting of: a start time indication, an end time indication, a duration indication, and a periodicity indication.
Clause 59. The user equipment of any of clauses 51 to 58, wherein the one or more areas are network-initiated areas, and wherein the one or more processors, either alone or in combination, are further configured to: transmit, via the one or more transceivers, a message identifying one or more UE-initiated areas.
Clause 60. The user equipment of clause 59, wherein at least one of the one or more UE-initiated areas partially or fully overlaps at least one of the one or more areas.
Clause 61. The user equipment of any of clauses 51 to 60, wherein the area-specific positioning comprises Artificial Intelligence/Machine Learning (AI/ML) positioning.
Clause 62. The user equipment of clause 61, wherein the one or more processors, either alone or in combination, are further configured to: obtain one or more measurements of one or more reference signals in the first area; and apply a machine learning model to the one or more measurements of one or more reference signals in the first area to obtain area-specific positioning information.
Clause 63. The user equipment of clause 62, wherein the one or more processors, either alone or in combination, are further configured to: apply the machine learning model to the one or more measurements of one or more reference signals in response to a position of the UE, a current time, or both.
Clause 64. The user equipment of clause 63, wherein the one or more processors, either alone or in combination, are further configured to: at a subsequent time, determine to: deactivate AI/ML positioning for the machine learning model, apply a different machine learning model to the one or more measurements, select a different positioning technique, switch to a fallback positioning technique, or a combination thereof.
Clause 65. The user equipment of any of clauses 62 to 64, wherein the one or more processors, either alone or in combination, are further configured to: receive, via the one or more transceivers, an indication to perform AI/ML positioning; and apply the machine learning model to the one or more measurements in response to the indication to perform AI/ML positioning.
Clause 66. The user equipment of clause 65, wherein the one or more processors, either alone or in combination, are further configured to: subsequent to receiving the indication to perform AI/ML positioning, receive an indication to deactivate AI/ML positioning.
Clause 67. The user equipment of clause 66, wherein the one or more processors, either alone or in combination, are further configured to: transmit, via the one or more transceivers, an indication to a network entity to initiate deactivation of the AI/ML positioning, and wherein the indication to deactivate AI/ML positioning is received in response to the transmission.
Clause 68. The user equipment of any of clauses 65 to 67, wherein the one or more processors, either alone or in combination, are further configured to: subsequent to receiving the indication to perform the AI/ML positioning, receive an indication to switch to a different positioning method.
Clause 69. The user equipment of clause 68, wherein the indication to switch to the different positioning method is an indication to switch to a fallback positioning method.
Clause 70. The user equipment of any of clauses 68 to 69, wherein the one or more processors, either alone or in combination, are further configured to: transmit, via the one or more transceivers, an indication to a network entity to initiate the switch to the different positioning method, and wherein the indication to switch to the different positioning method is received in response to the transmission.
Clause 71. The user equipment of any of clauses 65 to 70, wherein the one or more processors, either alone or in combination, are further configured to: subsequent to receiving the indication to perform AI/ML positioning, receive an indication to switch to a different machine learning model.
Clause 72. The user equipment of clause 71, wherein the indication to switch to the different machine learning model comprises an indication that the UE is in or proximate to a different area than the first area, and wherein the UE supports AI/ML positioning in the different area.
Clause 73. The user equipment of any of clauses 71 to 72, wherein the one or more processors, either alone or in combination, are further configured to: transmit, via the one or more transceivers, an indication to a network entity to initiate the switch to the different machine learning model, and wherein the indication to switch to the different machine learning model is received in response to the transmission.
Clause 74. The user equipment of any of clauses 61 to 73, wherein the one or more processors, either alone or in combination, are configured to transmit the indication of support for area-specific positioning in at least the first area of the one or more areas in response to a request for a capability of the UE to perform AI/ML positioning.
Clause 75. The user equipment of any of clauses 62 to 74, wherein the one or more measurements include sensing measurements or positioning measurements or both.
Clause 76. The user equipment of any of clauses 51 to 75, wherein the area information for the first area includes an area description, the area description including timing information indicating one or more time ranges during which area-specific positioning is supported in the first area.
Clause 77. The user equipment of clause 76, wherein the one or more processors, either alone or in combination, are further configured to: determine to perform the area-specific positioning in the first area based at least in part on determining that a current time is included in the one or more time ranges.
Clause 78. The user equipment of any of clauses 76 to 77, wherein the timing information includes validity timer information, range of area validity timing information, periodic validity time information, or a combination thereof.
Clause 79. The user equipment of any of clauses 51 to 78, wherein the one or more processors, either alone or in combination, are further configured to: determine that the UE is located in or proximate to the first area; and perform the area-specific positioning in the first area in response to the determining.
Clause 80. The user equipment of any of clauses 51 to 79, wherein the one or more processors, either alone or in combination, are further configured to: receive, via the one or more transceivers, an instruction to perform the area-specific positioning in the first area based on a position of the UE, a current time, or both; and perform the area-specific positioning in the first area in response to the instruction.
Clause 81. The user equipment of any of clauses 51 to 80, wherein the area information for the one or more areas includes an area ID for each of the one or more areas, wherein the area IDs for the one or more areas include a first portion identifying an area listing and a second portion identifying an area within the area listing.
Clause 82. The user equipment of clause 81, wherein the first portion identifying the area listing identifies whether the area is network-initiated or UE-initiated.
Clause 83. The user equipment of any of clauses 51 to 82, wherein the area information for the one or more areas includes an area ID for each of the one or more areas, wherein the area IDs for the one or more areas include a plurality of portions each associated with a hierarchy level, the plurality of portions including a group identifier associated with an area listing having a first hierarchy level, a subgroup identifier identifying an area listing having a second hierarchy level, and an item identifier identifying the area at a third hierarchy level.
Clause 84. A user equipment (UE), comprising: one or more memories; one or more transceivers; and one or more processors communicatively coupled to the one or more memories and the one or more transceivers, the one or more processors, either alone or in combination, configured to: transmit, via the one or more transceivers, a message identifying one or more UE-initiated areas, the message including an area identifier (ID), area description, or both for the one or more UE-initiated areas.
Clause 85. The user equipment of clause 84, wherein the message includes an area description for the one or more UE-initiated areas, wherein the area description includes geospatial parameters, timing parameters, or both.
Clause 86. The user equipment of any of clauses 84 to 85, wherein the message includes an area ID for each of the one or more UE-initiated areas, and wherein at least one of the one or more UE-initiated areas includes a plurality of non-contiguous area segments associated with a same area ID.
Clause 87. The user equipment of any of clauses 84 to 86, wherein the one or more processors, either alone or in combination, are further configured to: perform area-specific positioning in a first area of the one or more UE-initiated areas.
Clause 88. The user equipment of clause 87, wherein the area-specific positioning is AI/ML positioning, and wherein the one or more processors, either alone or in combination, are further configured to: obtain one or more measurements of one or more reference signals; and apply a machine learning model to the one or more measurements of the one or more reference signals in the first area to obtain area-specific positioning information to perform the area-specific positioning.
Clause 89. A network entity, comprising: one or more memories; one or more transceivers; and one or more processors communicatively coupled to the one or more memories and the one or more transceivers, the one or more processors, either alone or in combination, configured to: transmit, via the one or more transceivers, area information for one or more areas to a user equipment (UE), the area information including area identifiers (IDs) of the one or more areas, an area description of the one or more areas, or both; and receive, via the one or more transceivers, an indication of support for area-specific positioning in at least a first area of the one or more areas.
Clause 90. The network entity of clause 89, wherein the area information for each of the one or more areas includes an associated area description including geospatial parameters, timing parameters, or both.
Clause 91. The network entity of clause 90, wherein the geospatial parameters include latitude information, longitude information, altitude information, or a combination thereof.
Clause 92. The network entity of any of clauses 90 to 91, wherein the timing parameters include area validity timer information, validity timing range information, validity start time, validity end time, or a combination thereof.
Clause 93. The network entity of any of clauses 89 to 92, wherein the one or more areas are network-initiated areas, and wherein the one or more processors, either alone or in combination, are further configured to: receive, via the one or more transceivers, a message identifying one or more UE-initiated areas.
Clause 94. The network entity of any of clauses 89 to 93, wherein the area-specific positioning comprises Artificial Intelligence/Machine Learning (AI/ML) positioning, and wherein the one or more processors, either alone or in combination, are further configured to: instruct the UE to perform the AI/ML positioning at a first time.
Clause 95. The network entity of clause 94, wherein the one or more processors, either alone or in combination, are further configured to: at a second time subsequent to the first time, instruct the UE to: deactivate AI/ML positioning, switch to a different machine learning model, select a different positioning technique, switch to a fallback positioning technique, or a combination thereof.
Clause 96. The network entity of any of clauses 89 to 95, wherein the one or more processors, either alone or in combination, are further configured to: determine that a UE is located in or proximate to the first area; and instruct the UE to perform the area-specific positioning in the first area in response to the determining.
Clause 97. A network entity, comprising: one or more memories; one or more transceivers; and one or more processors communicatively coupled to the one or more memories and the one or more transceivers, the one or more processors, either alone or in combination, configured to: receive, via the one or more transceivers, from a user equipment (UE), a message identifying one or more UE-initiated areas, the message including an area identifier (ID), area description, or both for the one or more UE-initiated areas.
Clause 98. The network entity of clause 97, wherein the message includes an area description for the one or more UE-initiated areas, wherein the area description includes geospatial parameters, timing parameters, or both.
Clause 99. The network entity of any of clauses 97 to 98, wherein the one or more processors, either alone or in combination, are further configured to: instruct the UE to perform area-specific positioning in a first area of the one or more UE-initiated areas.
Clause 100. The network entity of clause 99, wherein the area-specific positioning is AI/ML positioning, and wherein the one or more processors, either alone or in combination, are further configured to: receive, via the one or more transceivers, positioning information from the UE, the positioning information obtained using a machine learning model.
Clause 101. A user equipment (UE), comprising: means for receiving area information for one or more areas, the area information including area identifiers (IDs) of the one or more areas, an area description of the one or more areas, or both; and means for transmitting an indication of support for area-specific positioning in at least a first area of the one or more areas.
Clause 102. The user equipment of clause 101, further comprising: means for obtaining one or more measurements of one or more reference signals in the first area; and means for performing the area-specific positioning in the first area using the one or more measurements of the one or more reference signals.
Clause 103. The user equipment of any of clauses 101 to 102, wherein the area information for each of the one or more areas includes an associated area description including geospatial parameters, timing parameters, or both.
Clause 104. The user equipment of clause 103, wherein the geospatial parameters include latitude information, longitude information, altitude information, or a combination thereof.
Clause 105. The user equipment of any of clauses 103 to 104, wherein the timing parameters include area validity timer information, validity timing range information, validity start time, validity end time, or a combination thereof.
Clause 106. The user equipment of any of clauses 103 to 105, wherein the timing parameters are expressed using coordinated universal time (UTC), hyper frame number, frame number, orthogonal frequency division multiplexing (OFDM) symbol number, or a combination thereof.
Clause 107. The user equipment of any of clauses 103 to 106, wherein the timing parameters include at least some non-contiguous timing information.
Clause 108. The user equipment of clause 107, wherein the non-contiguous timing information includes at least one indication selected from a group consisting of: a start time indication, an end time indication, a duration indication, and a periodicity indication.
Clause 109. The user equipment of any of clauses 101 to 108, wherein the one or more areas are network-initiated areas, and further comprising: means for transmitting a message identifying one or more UE-initiated areas.
Clause 110. The user equipment of clause 109, wherein at least one of the one or more UE-initiated areas partially or fully overlaps at least one of the one or more areas.
Clause 111. The user equipment of any of clauses 101 to 110, wherein the area-specific positioning comprises Artificial Intelligence/Machine Learning (AI/ML) positioning.
Clause 112. The user equipment of clause 111, further comprising: means for obtaining one or more measurements of one or more reference signals in the first area; and means for applying a machine learning model to the one or more measurements of one or more reference signals in the first area to obtain area-specific positioning information.
Clause 113. The user equipment of clause 112, further comprising: means for applying the machine learning model to the one or more measurements of one or more reference signals in response to a position of the UE, a current time, or both.
Clause 114. The user equipment of clause 113, further comprising: means for determining to, at a subsequent time: deactivate AI/ML positioning for the machine learning model, apply a different machine learning model to the one or more measurements, select a different positioning technique, switch to a fallback positioning technique, or a combination thereof.
Clause 115. The user equipment of any of clauses 112 to 114, further comprising: means for receiving an indication to perform AI/ML positioning; and wherein applying the machine learning model to the one or more measurements is in response to the indication to perform AI/ML positioning.
Clause 116. The user equipment of clause 115, further comprising: means for receiving an indication to deactivate AI/ML positioning subsequent to receiving the indication to perform AI/ML positioning.
Clause 117. The user equipment of clause 116, further comprising: means for transmitting an indication to a network entity to initiate deactivation of the AI/ML positioning; and wherein the indication to deactivate AI/ML positioning is received in response to the transmitting.
Clause 118. The user equipment of any of clauses 115 to 117, further comprising: means for receiving an indication to switch to a different positioning method subsequent to receiving the indication to perform the AI/ML positioning.
Clause 119. The user equipment of clause 118, wherein the indication to switch to the different positioning method is an indication to switch to a fallback positioning method.
Clause 120. The user equipment of any of clauses 118 to 119, further comprising: means for transmitting an indication to a network entity to initiate the switch to the different positioning method; and wherein the indication to switch to the different positioning method is received in response to the transmitting.
Clause 121. The user equipment of any of clauses 115 to 120, further comprising: means for receiving an indication to switch to a different machine learning model subsequent to receiving the indication to perform AI/ML positioning.
Clause 122. The user equipment of clause 121, wherein the indication to switch to the different machine learning model comprises an indication that the UE is in or proximate to a different area than the first area, and wherein the UE supports AI/ML positioning in the different area.
Clause 123. The user equipment of any of clauses 121 to 122, further comprising: means for transmitting an indication to a network entity to initiate the switch to the different machine learning model; and wherein the indication to switch to the different machine learning model is received in response to the transmitting.
Clause 124. The user equipment of any of clauses 111 to 123, wherein the means for transmitting an indication of support for area-specific positioning in at least the first area of the one or more areas comprises means for transmitting the indication in response to a request for a capability of the UE to perform AI/ML positioning.
Clause 125. The user equipment of any of clauses 112 to 124, wherein the one or more measurements include sensing measurements or positioning measurements or both.
Clause 126. The user equipment of any of clauses 101 to 125, wherein the area information for the first area includes an area description, the area description including timing information indicating one or more time ranges during which area-specific positioning is supported in the first area.
Clause 127. The user equipment of clause 126, further comprising: means for determining to perform the area-specific positioning in the first area based at least in part on determining that a current time is included in the one or more time ranges.
Clause 128. The user equipment of any of clauses 126 to 127, wherein the timing information includes validity timer information, range of area validity timing information, periodic validity time information, or a combination thereof.
Clause 129. The user equipment of any of clauses 101 to 128, further comprising: means for determining that the UE is located in or proximate to the first area; and means for performing the area-specific positioning in the first area in response to the determining.
Clause 130. The user equipment of any of clauses 101 to 129, further comprising: means for receiving an instruction to perform the area-specific positioning in the first area based on a position of the UE, a current time, or both; and means for performing the area-specific positioning in the first area in response to the instruction.
Clause 131. The user equipment of any of clauses 101 to 130, wherein the area information for the one or more areas includes an area ID for each of the one or more areas, wherein the area IDs for the one or more areas include a first portion identifying an area listing and a second portion identifying an area within the area listing.
Clause 132. The user equipment of clause 131, wherein the first portion identifying the area listing identifies whether the area is network-initiated or UE-initiated.
Clause 133. The user equipment of any of clauses 101 to 132, wherein the area information for the one or more areas includes an area ID for each of the one or more areas, wherein the area IDs for the one or more areas include a plurality of portions each associated with a hierarchy level, the plurality of portions including a group identifier associated with an area listing having a first hierarchy level, a subgroup identifier identifying an area listing having a second hierarchy level, and an item identifier identifying the area at a third hierarchy level.
Clause 134. A user equipment (UE), comprising: means for transmitting a message identifying one or more UE-initiated areas, the message including an area identifier (ID), area description, or both for the one or more UE-initiated areas.
Clause 135. The user equipment of clause 134, wherein the message includes an area description for the one or more UE-initiated areas, wherein the area description includes geospatial parameters, timing parameters, or both.
Clause 136. The user equipment of any of clauses 134 to 135, wherein the message includes an area ID for each of the one or more UE-initiated areas, and wherein at least one of the one or more UE-initiated areas includes a plurality of non-contiguous area segments associated with a same area ID.
Clause 137. The user equipment of any of clauses 134 to 136, further comprising: means for performing area-specific positioning in a first area of the one or more UE-initiated areas.
Clause 138. The user equipment of clause 137, wherein the area-specific positioning is AI/ML positioning, and wherein performing area-specific positioning in the first area comprises: means for obtaining one or more measurements of one or more reference signals; and means for applying a machine learning model to the one or more measurements of the one or more reference signals in the first area to obtain area-specific positioning information.
Clause 139. A network entity, comprising: means for transmitting area information for one or more areas to a user equipment (UE), the area information including area identifiers (IDs) of the one or more areas, an area description of the one or more areas, or both; and means for receiving an indication of support for area-specific positioning in at least a first area of the one or more areas.
Clause 140. The network entity of clause 139, wherein the area information for each of the one or more areas includes an associated area description including geospatial parameters, timing parameters, or both.
Clause 141. The network entity of clause 140, wherein the geospatial parameters include latitude information, longitude information, altitude information, or a combination thereof.
Clause 142. The network entity of any of clauses 140 to 141, wherein the timing parameters include area validity timer information, validity timing range information, validity start time, validity end time, or a combination thereof.
Clause 143. The network entity of any of clauses 139 to 142, wherein the one or more areas are network-initiated areas, and further comprising: means for receiving a message identifying one or more UE-initiated areas.
Clause 144. The network entity of any of clauses 139 to 143, wherein the area-specific positioning comprises Artificial Intelligence/Machine Learning (AI/ML) positioning, and further comprising: means for instructing the UE to perform the AI/ML positioning at a first time.
Clause 145. The network entity of clause 144, further comprising: means for instructing the UE to, at a second time subsequent to the first time: deactivate AI/ML positioning, switch to a different machine learning model, select a different positioning technique, switch to a fallback positioning technique, or a combination thereof.
Clause 146. The network entity of any of clauses 139 to 145, further comprising: means for determining that a UE is located in or proximate to the first area; and means for instructing the UE to perform the area-specific positioning in the first area in response to the determining.
Clause 147. A network entity, comprising: means for receiving, from a user equipment (UE), a message identifying one or more UE-initiated areas, the message including an area identifier (ID), area description, or both for the one or more UE-initiated areas.
Clause 148. The network entity of clause 147, wherein the message includes an area description for the one or more UE-initiated areas, wherein the area description includes geospatial parameters, timing parameters, or both.
Clause 149. The network entity of any of clauses 147 to 148, further comprising: means for instructing the UE to perform area-specific positioning in a first area of the one or more UE-initiated areas.
Clause 150. The network entity of clause 149, wherein the area-specific positioning is AI/ML positioning, and further comprising: means for receiving positioning information from the UE, the positioning information obtained using a machine learning model.
Clause 151. A non-transitory computer-readable medium storing computer-executable instructions that, when executed by a user equipment (UE), cause the user equipment to: receive area information for one or more areas, the area information including area identifiers (IDs) of the one or more areas, an area description of the one or more areas, or both; and transmit an indication of support for area-specific positioning in at least a first area of the one or more areas.
Clause 152. The non-transitory computer-readable medium of clause 151, further comprising computer-executable instructions that, when executed by the user equipment, cause the user equipment to: obtain one or more measurements of one or more reference signals in the first area; and perform the area-specific positioning in the first area using the one or more measurements of the one or more reference signals.
Clause 153. The non-transitory computer-readable medium of any of clauses 151 to 152, wherein the area information for each of the one or more areas includes an associated area description including geospatial parameters, timing parameters, or both.
Clause 154. The non-transitory computer-readable medium of clause 153, wherein the geospatial parameters include latitude information, longitude information, altitude information, or a combination thereof.
Clause 155. The non-transitory computer-readable medium of any of clauses 153 to 154, wherein the timing parameters include area validity timer information, validity timing range information, validity start time, validity end time, or a combination thereof.
Clause 156. The non-transitory computer-readable medium of any of clauses 153 to 155, wherein the timing parameters are expressed using coordinated universal time (UTC), hyper frame number, frame number, orthogonal frequency division multiplexing (OFDM) symbol number, or a combination thereof.
Clause 157. The non-transitory computer-readable medium of any of clauses 153 to 156, wherein the timing parameters include at least some non-contiguous timing information.
Clause 158. The non-transitory computer-readable medium of clause 157, wherein the non-contiguous timing information includes at least one indication selected from a group consisting of: a start time indication, an end time indication, a duration indication, and a periodicity indication.
Clause 159. The non-transitory computer-readable medium of any of clauses 151 to 158, wherein the one or more areas are network-initiated areas, and further comprising computer-executable instructions that, when executed by the user equipment, cause the user equipment to: transmit a message identifying one or more UE-initiated areas.
Clause 160. The non-transitory computer-readable medium of clause 159, wherein at least one of the one or more UE-initiated areas partially or fully overlaps at least one of the one or more areas.
Clause 161. The non-transitory computer-readable medium of any of clauses 151 to 160, wherein the area-specific positioning comprises Artificial Intelligence/Machine Learning (AI/ML) positioning.
Clause 162. The non-transitory computer-readable medium of clause 161, further comprising computer-executable instructions that, when executed by the user equipment, cause the user equipment to: obtain one or more measurements of one or more reference signals in the first area; and apply a machine learning model to the one or more measurements of one or more reference signals in the first area to obtain area-specific positioning information.
Clause 163. The non-transitory computer-readable medium of clause 162, further comprising computer-executable instructions that, when executed by the user equipment, cause the user equipment to: apply the machine learning model to the one or more measurements of one or more reference signals in response to a position of the UE, a current time, or both.
Clause 164. The non-transitory computer-readable medium of clause 163, further comprising computer-executable instructions that, when executed by the user equipment, cause the user equipment to: determine to, at a subsequent time: deactivate AI/ML positioning for the machine learning model, apply a different machine learning model to the one or more measurements, select a different positioning technique, switch to a fallback positioning technique, or a combination thereof.
Clause 165. The non-transitory computer-readable medium of any of clauses 162 to 164, further comprising computer-executable instructions that, when executed by the user equipment, cause the user equipment to: receive an indication to perform AI/ML positioning; and wherein applying the machine learning model to the one or more measurements is in response to the indication to perform AI/ML positioning.
Clause 166. The non-transitory computer-readable medium of clause 165, further comprising computer-executable instructions that, when executed by the user equipment, cause the user equipment to: subsequent to receiving the indication to perform AI/ML positioning, receive an indication to deactivate AI/ML positioning.
Clause 167. The non-transitory computer-readable medium of clause 166, further comprising computer-executable instructions that, when executed by the user equipment, cause the user equipment to: transmit an indication to a network entity to initiate deactivation of the AI/ML positioning; and wherein the indication to deactivate AI/ML positioning is received in response to the transmitting.
Clause 168. The non-transitory computer-readable medium of any of clauses 165 to 167, further comprising computer-executable instructions that, when executed by the user equipment, cause the user equipment to: receive an indication to switch to a different positioning method subsequent to receiving the indication to perform the AI/ML positioning.
Clause 169. The non-transitory computer-readable medium of clause 168, wherein the indication to switch to the different positioning method is an indication to switch to a fallback positioning method.
Clause 170. The non-transitory computer-readable medium of any of clauses 168 to 169, further comprising computer-executable instructions that, when executed by the user equipment, cause the user equipment to: transmit an indication to a network entity to initiate the switch to the different positioning method; and wherein the indication to switch to the different positioning method is received in response to the transmitting.
Clause 171. The non-transitory computer-readable medium of any of clauses 165 to 170, further comprising computer-executable instructions that, when executed by the user equipment, cause the user equipment to: receive an indication to switch to a different machine learning model subsequent to receiving the indication to perform AI/ML positioning.
Clause 172. The non-transitory computer-readable medium of clause 171, wherein the indication to switch to the different machine learning model comprises an indication that the UE is in or proximate to a different area than the first area, and wherein the UE supports AI/ML positioning in the different area.
Clause 173. The non-transitory computer-readable medium of any of clauses 171 to 172, further comprising computer-executable instructions that, when executed by the user equipment, cause the user equipment to: transmit an indication to a network entity to initiate the switch to the different machine learning model; and wherein the indication to switch to the different machine learning model is received in response to the transmitting.
Clause 174. The non-transitory computer-readable medium of any of clauses 161 to 173, wherein the instructions cause the user equipment to transmit the indication of support for area-specific positioning in at least the first area of the one or more areas is in response to a request for a capability of the UE to perform AI/ML positioning.
Clause 175. The non-transitory computer-readable medium of any of clauses 162 to 174, wherein the one or more measurements include sensing measurements or positioning measurements or both.
Clause 176. The non-transitory computer-readable medium of any of clauses 151 to 175, wherein the area information for the first area includes an area description, the area description including timing information indicating one or more time ranges during which area-specific positioning is supported in the first area.
Clause 177. The non-transitory computer-readable medium of clause 176, further comprising computer-executable instructions that, when executed by the user equipment, cause the user equipment to: determine to perform the area-specific positioning in the first area based at least in part on determining that a current time is included in the one or more time ranges.
Clause 178. The non-transitory computer-readable medium of any of clauses 176 to 177, wherein the timing information includes validity timer information, range of area validity timing information, periodic validity time information, or a combination thereof.
Clause 179. The non-transitory computer-readable medium of any of clauses 151 to 178, further comprising computer-executable instructions that, when executed by the user equipment, cause the user equipment to: determine that the UE is located in or proximate to the first area; and perform the area-specific positioning in the first area in response to the determining.
Clause 180. The non-transitory computer-readable medium of any of clauses 151 to 179, further comprising computer-executable instructions that, when executed by the user equipment, cause the user equipment to: receive an instruction to perform the area-specific positioning in the first area based on a position of the UE, a current time, or both; band perform the area-specific positioning in the first area in response to the instruction.
Clause 181. The non-transitory computer-readable medium of any of clauses 151 to 180, wherein the area information for the one or more areas includes an area ID for each of the one or more areas, wherein the area IDs for the one or more areas include a first portion identifying an area listing and a second portion identifying an area within the area listing.
Clause 182. The non-transitory computer-readable medium of clause 181, wherein the first portion identifying the area listing identifies whether the area is network-initiated or UE-initiated.
Clause 183. The non-transitory computer-readable medium of any of clauses 151 to 182, wherein the area information for the one or more areas includes an area ID for each of the one or more areas, wherein the area IDs for the one or more areas include a plurality of portions each associated with a hierarchy level, the plurality of portions including a group identifier associated with an area listing having a first hierarchy level, a subgroup identifier identifying an area listing having a second hierarchy level, and an item identifier identifying the area at a third hierarchy level.
Clause 184. A non-transitory computer-readable medium storing computer-executable instructions that, when executed by a user equipment (UE), cause the user equipment to: transmit a message identifying one or more UE-initiated areas, the message including an area identifier (ID), area description, or both for the one or more UE-initiated areas.
Clause 185. The non-transitory computer-readable medium of clause 184, wherein the message includes an area description for the one or more UE-initiated areas, wherein the area description includes geospatial parameters, timing parameters, or both.
Clause 186. The non-transitory computer-readable medium of any of clauses 184 to 185, wherein the message includes an area ID for each of the one or more UE-initiated areas, and wherein at least one of the one or more UE-initiated areas includes a plurality of non-contiguous area segments associated with a same area ID.
Clause 187. The non-transitory computer-readable medium of any of clauses 184 to 186, further comprising computer-executable instructions that, when executed by the user equipment, cause the user equipment to: perform area-specific positioning in a first area of the one or more UE-initiated areas.
Clause 188. The non-transitory computer-readable medium of clause 187, wherein the area-specific positioning is AI/ML positioning, and wherein the computer-executable instructions to perform area-specific positioning in the first area comprise computer-executable instructions that, when executed by the user equipment, cause the user equipment to: obtain one or more measurements of one or more reference signals; and apply a machine learning model to the one or more measurements of the one or more reference signals in the first area to obtain area-specific positioning information.
Clause 189. A non-transitory computer-readable medium storing computer-executable instructions that, when executed by a network entity, cause the network entity to: transmit area information for one or more areas to a user equipment (UE), the area information including area identifiers (IDs) of the one or more areas, an area description of the one or more areas, or both; and receive an indication of support for area-specific positioning in at least a first area of the one or more areas.
Clause 190. The non-transitory computer-readable medium of clause 189, wherein the area information for each of the one or more areas includes an associated area description including geospatial parameters, timing parameters, or both.
Clause 191. The non-transitory computer-readable medium of clause 190, wherein the geospatial parameters include latitude information, longitude information, altitude information, or a combination thereof.
Clause 192. The non-transitory computer-readable medium of any of clauses 190 to 191, wherein the timing parameters include area validity timer information, validity timing range information, validity start time, validity end time, or a combination thereof.
Clause 193. The non-transitory computer-readable medium of any of clauses 189 to 192, wherein the one or more areas are network-initiated areas, and further comprising computer-executable instructions that, when executed by the network entity, cause the network entity to: receive a message identifying one or more UE-initiated areas.
Clause 194. The non-transitory computer-readable medium of any of clauses 189 to 193, wherein the area-specific positioning comprises Artificial Intelligence/Machine Learning

(AI/ML) positioning, and further comprising computer-executable instructions that, when executed by the user equipment, cause the user equipment to: instruct the UE to perform the AI/ML positioning at a first time.
Clause 195. The non-transitory computer-readable medium of clause 194, further comprising computer-executable instructions that, when executed by the network entity, cause the network entity to: at a second time subsequent to the first time, instruct the UE to: deactivate AI/ML positioning, switch to a different machine learning model, select a different positioning technique, switch to a fallback positioning technique, or a combination thereof.
Clause 196. The non-transitory computer-readable medium of any of clauses 189 to 195, further comprising computer-executable instructions that, when executed by the network entity, cause the network entity to: determine that a UE is located in or proximate to the first area; and instruct the UE to perform the area-specific positioning in the first area in response to the determining.
Clause 197. A non-transitory computer-readable medium storing computer-executable instructions that, when executed by a network entity, cause the network entity to: receive, from a user equipment (UE), a message identifying one or more UE-initiated areas, the message including an area identifier (ID), area description, or both for the one or more UE-initiated areas.
Clause 198. The non-transitory computer-readable medium of clause 197, wherein the message includes an area description for the one or more UE-initiated areas, wherein the area description includes geospatial parameters, timing parameters, or both.
Clause 199. The non-transitory computer-readable medium of any of clauses 197 to 198, further comprising computer-executable instructions that, when executed by the network entity, cause the network entity to: instruct the UE to perform area-specific positioning in a first area of the one or more UE-initiated areas.
Clause 200. The non-transitory computer-readable medium of clause 199, wherein the area-specific positioning is AI/ML positioning, and further comprising computer-executable instructions that, when executed by the network entity, cause the network entity to: receive positioning information from the UE, the positioning information obtained using a machine learning model.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication at a user equipment (UE) comprising:
receiving area information for one or more areas, the area information including area identifiers (IDs) of the one or more areas, an area description of the one or more areas, or both; and
transmitting an indication of support for area-specific positioning in at least a first area of the one or more areas.

2. The method of claim 1, further comprising:
obtaining one or more measurements of one or more reference signals in the first area; and
performing the area-specific positioning in the first area using the one or more measurements of the one or more reference signals.

3. The method of claim 1, wherein the area information for each of the one or more areas includes an associated area description including geospatial parameters, timing parameters, or both.

4. The method of claim 1, wherein the area-specific positioning comprises Artificial Intelligence/Machine Learning (AI/ML) positioning.

5. The method of claim 4, further comprising:
obtaining one or more measurements of one or more reference signals in the first area; and
applying a machine learning model to the one or more measurements of one or more reference signals in the first area to obtain area-specific positioning information.

6. The method of claim 4, wherein transmitting an indication of support for area-specific positioning in at least the first area of the one or more areas is in response to a request for a capability of the UE to perform AI/ML positioning.

7. The method of claim 5, wherein the one or more measurements include sensing measurements or positioning measurements or both.

8. The method of claim 1, wherein the area information for the one or more areas includes an area ID for each of the one or more areas, wherein the area IDs for the one or more areas include a first portion identifying an area listing and a second portion identifying an area within the area listing.

9. The method of claim 8, wherein the first portion identifying the area listing identifies whether the area is network-initiated or UE-initiated.

10. A method of wireless communication at a user equipment (UE) comprising:
transmitting a message identifying one or more UE-initiated areas, the message including an area identifier (ID), area description, or both for the one or more UE-initiated areas.

11. The method of claim 10, wherein the message includes an area description for the one or more UE-initiated areas, wherein the area description includes geospatial parameters, timing parameters, or both.

12. The method of claim 10, further comprising:
performing area-specific positioning in a first area of the one or more UE-initiated areas, wherein the area-specific positioning is AI/ML positioning, and wherein performing area-specific positioning in the first area comprises:
obtaining one or more measurements of one or more reference signals; and
applying a machine learning model to the one or more measurements of the one or more reference signals in the first area to obtain area-specific positioning information.

13. A method of communication at a network entity comprising:
transmitting area information for one or more areas to a user equipment (UE), the area information including area identifiers (IDs) of the one or more areas, an area description of the one or more areas, or both; and
receiving an indication of support for area-specific positioning in at least a first area of the one or more areas.

14. The method of claim 13, wherein the area information for each of the one or more areas includes an associated area description including geospatial parameters, timing parameters, or both.

15. The method of claim 13, wherein the area-specific positioning comprises Artificial Intelligence/Machine Learning (AI/ML) positioning, and further comprising:
instructing the UE to perform the AI/ML positioning at a first time.

16. A method of communication at a network entity comprising:
receiving, from a user equipment (UE), a message identifying one or more UE-initiated areas, the message including an area identifier (ID), area description, or both for the one or more UE-initiated areas.

17. The method of claim 16, wherein the message includes an area description for the one or more UE-initiated areas, wherein the area description includes geospatial parameters, timing parameters, or both.

18. A user equipment (UE), comprising:
one or more memories;
one or more transceivers; and
one or more processors communicatively coupled to the one or more memories and the one or more transceivers, the one or more processors, either alone or in combination, configured to:
receive, via the one or more transceivers, area information for one or more areas, the area information including area identifiers (IDs) of the one or more areas, an area description of the one or more areas, or both; and
transmit, via the one or more transceivers, an indication of support for area-specific positioning in at least a first area of the one or more areas.

19. The user equipment of claim 18, wherein the one or more processors, either alone or in combination, are further configured to:
obtain one or more measurements of one or more reference signals in the first area; and
perform the area-specific positioning in the first area using the one or more measurements of the one or more reference signals.

20. The user equipment of claim 18, wherein the area information for each of the one or more areas includes an associated area description including geospatial parameters, timing parameters, or both.

21. The user equipment of claim 20, wherein the geospatial parameters include latitude information, longitude information, altitude information, or a combination thereof.

22. The user equipment of claim 20, wherein the timing parameters include area validity timer information, validity timing range information, validity start time, validity end time, or a combination thereof.

23. The user equipment of claim 20, wherein the timing parameters include at least some non-contiguous timing information, the non-contiguous timing information comprising at least one indication selected from a group consisting of: a start time indication, an end time indication, a duration indication, and a periodicity indication.

24. The user equipment of claim 18, wherein the one or more areas are network-initiated areas, and wherein the one or more processors, either alone or in combination, are further configured to:
transmit, via the one or more transceivers, a message identifying one or more UE-initiated areas.

25. The user equipment of claim 24, wherein at least one of the one or more UE-initiated areas partially or fully overlaps at least one of the one or more areas.

26. The user equipment of claim 18, wherein the area-specific positioning comprises Artificial Intelligence/Machine Learning (AI/ML) positioning.

27. The user equipment of claim 26, wherein the one or more processors, either alone or in combination, are further configured to:
obtain one or more measurements of one or more reference signals in the first area; and
apply a machine learning model to the one or more measurements of one or more reference signals in the first area to obtain area-specific positioning information.

28. The user equipment of claim 27, wherein the one or more processors, either alone or in combination, are further configured to:
apply the machine learning model to the one or more measurements of one or more reference signals in response to a position of the UE, a current time, or both.

29. The user equipment of claim 28, wherein the one or more processors, either alone or in combination, are further configured to:
at a subsequent time, determine to: deactivate AI/ML positioning for the machine learning model, apply a different machine learning model to the one or more measurements, select a different positioning technique, switch to a fallback positioning technique, or a combination thereof.

30. The user equipment of claim 27, wherein the one or more processors, either alone or in combination, are further configured to:
receive, via the one or more transceivers, an indication to perform AI/ML positioning; and
apply the machine learning model to the one or more measurements in response to the indication to perform AI/ML positioning.

31. The user equipment of claim 30, wherein the one or more processors, either alone or in combination, are further configured to:
subsequent to receiving the indication to perform AI/ML positioning, receive an indication to deactivate AI/ML positioning.

32. The user equipment of claim 31, wherein the one or more processors, either alone or in combination, are further configured to:
transmit, via the one or more transceivers, an indication to a network entity to initiate deactivation of the AI/ML positioning; and
wherein the indication to deactivate AI/ML positioning is received in response to the transmission.

33. The user equipment of claim 30, wherein the one or more processors, either alone or in combination, are further configured to:
subsequent to receiving the indication to perform the AI/ML positioning, receive an indication to switch to a different positioning method.

34. The user equipment of claim 33, wherein the indication to switch to the different positioning method is an indication to switch to a fallback positioning method.

35. The user equipment of claim 33, wherein the one or more processors, either alone or in combination, are further configured to:
transmit, via the one or more transceivers, an indication to a network entity to initiate the switch to the different positioning method; and
wherein the indication to switch to the different positioning method is received in response to the transmission.

36. The user equipment of claim 30, wherein the one or more processors, either alone or in combination, are further configured to:
subsequent to receiving the indication to perform AI/ML positioning, receive an indication to switch to a different machine learning model.

37. The user equipment of claim 36, wherein the indication to switch to the different machine learning model comprises an indication that the UE is in or proximate to a different area than the first area, and wherein the UE supports AI/ML positioning in the different area.

38. The user equipment of claim 36, wherein the one or more processors, either alone or in combination, are further configured to:
transmit, via the one or more transceivers, an indication to a network entity to initiate the switch to the different machine learning model; and
wherein the indication to switch to the different machine learning model is received in response to the transmission.

39. The user equipment of claim 18, wherein the area information for the first area includes an area description, the area description including timing information indicating one or more time ranges during which area-specific positioning is supported in the first area.

40. The user equipment of claim 39, wherein the one or more processors, either alone or in combination, are further configured to:
determine to perform the area-specific positioning in the first area based at least in part on determining that a current time is included in the one or more time ranges.

41. The user equipment of claim 39, wherein the timing information includes validity timer information, range of area validity timing information, periodic validity time information, or a combination thereof.

42. The user equipment of claim 18, wherein the one or more processors, either alone or in combination, are further configured to:
determine that the UE is located in or proximate to the first area; and
perform the area-specific positioning in the first area in response to the determining.

43. The user equipment of claim 18, wherein the one or more processors, either alone or in combination, are further configured to:
receive, via the one or more transceivers, an instruction to perform the area-specific positioning in the first area based on a position of the UE, a current time, or both; and
perform the area-specific positioning in the first area in response to the instruction.

44. The user equipment of claim 18, wherein the area information for the one or more areas includes an area ID for each of the one or more areas, wherein the area IDs for the one or more areas include a first portion identifying an area listing and a second portion identifying an area within the area listing.

45. The user equipment of claim 44, wherein the first portion identifying the area listing identifies whether the area is network-initiated or UE-initiated.

46. The user equipment of claim 18, wherein the area information for the one or more areas includes an area ID for each of the one or more areas, wherein the area IDs for the one or more areas include a plurality of portions each associated with a hierarchy level, the plurality of portions including a group identifier associated with an area listing having a first hierarchy level, a subgroup identifier identifying an area listing having a second hierarchy level, and an item identifier identifying the area at a third hierarchy level.

47. A user equipment (UE), comprising:
one or more memories;
one or more transceivers; and
one or more processors communicatively coupled to the one or more memories and the one or more transceivers, the one or more processors, either alone or in combination, configured to:
transmit, via the one or more transceivers, a message identifying one or more UE-initiated areas, the message including an area identifier (ID), area description, or both for the one or more UE-initiated areas.

48. The user equipment of claim 47, wherein the message includes an area description for the one or more UE-initiated areas, wherein the area description includes geospatial parameters, timing parameters, or both.

49. The user equipment of claim 47, wherein the message includes an area ID for each of the one or more UE-initiated areas, and wherein at least one of the one or more UE-initiated areas includes a plurality of non-contiguous area segments associated with a same area ID.

50. The user equipment of claim 47, wherein the one or more processors, either alone or in combination, are further configured to:
perform area-specific positioning in a first area of the one or more UE-initiated areas.

51. The user equipment of claim 50, wherein the area-specific positioning is AI/ML positioning, and wherein the one or more processors, either alone or in combination, are further configured to:
obtain one or more measurements of one or more reference signals; and
apply a machine learning model to the one or more measurements of the one or more reference signals in the first area to obtain area-specific positioning information to perform the area-specific positioning.

52. A network entity, comprising:
one or more memories;
one or more transceivers; and
one or more processors communicatively coupled to the one or more memories and the one or more transceivers, the one or more processors, either alone or in combination, configured to:
transmit, via the one or more transceivers, area information for one or more areas to a user equipment (UE), the area information including area identifiers (IDs) of the one or more areas, an area description of the one or more areas, or both; and
receive, via the one or more transceivers, an indication of support for area-specific positioning in at least a first area of the one or more areas.

53. The network entity of claim 52, wherein the area information for each of the one or more areas includes an associated area description including geospatial parameters, timing parameters, or both.

54. The network entity of claim 52, wherein the one or more areas are network-initiated areas, and wherein the one or more processors, either alone or in combination, are further configured to:
receive, via the one or more transceivers, a message identifying one or more UE-initiated areas.

55. The network entity of claim 52, wherein the area-specific positioning comprises Artificial Intelligence/Machine Learning (AI/ML) positioning, and wherein the one or more processors, either alone or in combination, are further configured to:
instruct the UE to perform the AI/ML positioning at a first time.

56. The network entity of claim 55, wherein the one or more processors, either alone or in combination, are further configured to:
at a second time subsequent to the first time, instruct the UE to: deactivate AI/ML positioning, switch to a different machine learning model, select a different positioning technique, switch to a fallback positioning technique, or a combination thereof.

57. A network entity, comprising:
one or more memories;
one or more transceivers; and
one or more processors communicatively coupled to the one or more memories and the one or more transceivers, the one or more processors, either alone or in combination, configured to:
receive, via the one or more transceivers, from a user equipment (UE), a message identifying one or more UE-initiated areas, the message including an area identifier (ID), area description, or both for the one or more UE-initiated areas.

58. The network entity of claim 57, wherein the message includes an area description for the one or more UE-initiated areas, wherein the area description includes geospatial parameters, timing parameters, or both.

59. The network entity of claim 57, wherein the one or more processors, either alone or in combination, are further configured to:
instruct the UE to perform area-specific positioning in a first area of the one or more UE-initiated areas.

60. The network entity of claim 59, wherein the area-specific positioning is AI/ML positioning, and wherein the one or more processors, either alone or in combination, are further configured to:
receive, via the one or more transceivers, positioning information from the UE, the positioning information obtained using a machine learning model.
